(19) United States
(12) Patent Application Publication
(10) Pub. No.: US 2013/0191137 A1
(43) Pub. Date: Jul. 25, 2013

(54) SYSTEMS AND METHODS FOR ELECTRONICALLY PRESCRIBING CONTROLLED SUBSTANCES

(71) Applicants: James F. Chen, Potomac, MD (US); Peter N. Kaufman, Potomac, MD (US); Brandon Brylawski, Bethesda, MD (US); Jieh-Shan Wang, North Potomac, MD (US); Eric Rosenfeld, Urbana, MD (US); Rishi Anand, Rockville, MD (US)

(72) Inventors: James F. Chen, Potomac, MD (US); Peter N. Kaufman, Potomac, MD (US); Brandon Brylawski, Bethesda, MD (US); Jieh-Shan Wang, North Potomac, MD (US); Eric Rosenfeld, Urbana, MD (US); Rishi Anand, Rockville, MD (US)

(21) Appl. No.: 13/405,889

(22) Filed: Feb. 27, 2012

Related U.S. Application Data
(60) Provisional application No. 61/589,796, filed on Jan. 23, 2012.

(51) Int. Cl. G06Q 50/22; H04L 9/32

(52) U.S. Cl. 705/2

(57) ABSTRACT

The present invention relates to a method for electronically prescribing controlled substances on a wide area network that includes a health care provider system (HCP system), an electronic prescription system (EP system), a third party identification validation system (third party IDV system), and a pharmacy system, and includes: a) the EP system receiving from the HCP system an electronic prescription entered by a provider for a controlled substance, a first identification factor, and a second identification factor; b) the EP system authenticating the first identification factor and transmitting the second identification factor to the third party IDV system for authentication; and c) upon the first identification factor being approved by the EP system and the EP system receiving approval of the second identification factor from the third party IDV system, the electronic prescription being certified for transmission to the pharmacy system as a certified electronic prescription for the controlled substance.

### CROSS-REFERENCE TO RELATED APPLICATIONS

The present application claims the benefit of United Stated Provisional Application Ser. No. 61/589,796, filed Jan. 23, 2012, the entirety of which is hereby incorporated by reference.

### FIELD OF THE INVENTION

The present invention relates generally to systems and methods for electronically prescribing controlled substances, and specifically to systems and methods for electronically prescribing controlled substances that use a multi-factor authentication process.

### BACKGROUND OF THE INVENTION

The ability to transmit prescriptions electronically is currently known and used by physicians, nurse practitioners and other providers who are authorized to prescribe drugs to their patients. Electronic prescribing allows for the provider to prescribe a drug to a patient without the undue hassle of tilling out and signing a physical piece of paper, which in turn, requires the patient to physically deliver the prescription to their local pharmacy only to return later to pick up the filled prescription. Among other added benefits, electronic prescription systems allows for the provider to receive information, such as the duration a prescription sits prior to being picked up by the patient, whether the patient is actually picking up their prescriptions and if and how much refills the patient fills.

However, present electronic prescription systems do not allow for a provider to electronically prescribe controlled substances, such as those listed as schedule II-VI drugs by the Drug Enforcement Administration (DEA). This is at least partially due to the added authentication requirements made mandatory by the DEA to ensure that controlled substances are not being improperly prescribed. Nonetheless, a provider of controlled substances may benefit from being able to ensure that the prescriptions they write for controlled substances are delivered to the patient's pharmacy. Further, due to the complication and potential for abuse of controlled substances, the provider would further benefit from the information provided to them when prescribing electronically. Therefore, there currently remains a need for a system, method and/or module that is capable of electronically prescribing controlled substances while adhering to DEA guidelines.

### SUMMARY OF THE INVENTION

These and other needs are net by the present invention, which is directed to a method for electronically prescribing a controlled substance on a wide area network, the wide area network comprising, in operable electronic communication, a health care provider system (HCP system), an electronic prescription system (EP system), a third party identification validation system (third party IDV system), and a pharmacy system, the method comprising: a) the EP system receiving from the HCP system an electronic prescription entered by a provider for a controlled substance, a first identification factor, and a second identification factor; b) the EP system authenticating the first identification factor and transmitting the second identification factor to the third party IDV system for authentication; and c) upon the first identification factor being approved by the EP system and the EP system receiving approval of the second identification factor from the third party IDV system, the electronic prescription being certified for transmission to the pharmacy system as a certified electronic prescription for the controlled substance.

In another aspect, the invention can be a wide area network system for electronically prescribing a controlled substance comprising: a health care provider system (HCP system), an electronic prescription system (EP system), a third party identification validation system (third party IDV system), and a pharmacy system; the HCP system transmitting to the EP system: (1) an electronic prescription for a controlled substance entered by a provider; (2) a first identification factor entered by the provider; and (3) a second identification factor entered by the provider, the EP system: (1) receiving from the HCP system the electronic prescription, the first identification factor, and the second identification factor; (2) authenticating the first identification factor; (3) transmitting the second identification factor to the third party IDV system for authentication; and (4) receiving approval of the second identification factor from the third party IDV system; the third party IDV system: (1) authenticating the second identification factor; and (2) transmitting approval of the second identification factor to the EP system; and the wide area network system: (1) certifying the electronic prescription upon the first identification factor being approved by the EP system and the EP system receiving approval of the second identification factor from the third party IDV system to create a certified electronic prescription; and (2) transmitting the certified electronic prescription to the pharmacy system.

In yet another aspect, the invention can be a wide area network system for electronically prescribing a controlled substance comprising: a health care provider (HCP) system; an electronic prescription (EP) system comprising a first identification factor database; a third party identification validation (third party IDV) system comprising a second identification factor database; a pharmacy system; and an electronic prescription of controlled substances (EPCS) module: (1) receiving an electronic prescription for a controlled substance entered by a provider; (2) receiving a first identification factor entered by the provider; (3) receiving a second identification factor entered by the provider; (4) authenticating the first identification factor using the first identification factor database; (5) transmitting the second identification factor to the third party IDV system for authentication; (6) receiving approval of the second identification factor from the third party IDV system; (7) certifying the electronic prescription upon the first identification factor being approved and approval of the second identification factor being received from the third party IDV system to create a certified electronic prescription; and (8) transmitting the certified electronic prescription to the pharmacy system; and the third party IDV system: (1) authenticating the second identification factor using the second identification factor database; and (2) transmitting approval of the second identification factor to the EPCS module.

In a further aspect, the invention can be a method for electronically prescribing a controlled substance on a wide area network, the wide area network comprising, in operable electronic communication, a health care provider system (HCP system), an electronic prescription system (EP system), an electronic prescription of controlled substances (EPCS) module, a third party identification validation system (third party IDV system), and a pharmacy system, the method comprising: a) the EPCS module receiving from the HCP system an electronic prescription entered by a provider for a controlled substance, a first identification factor, and a second identification factor; b) the EPCS module authenticating the first identification factor using a first identification factor database residing on the EP system and transmitting the second identification factor to the third party IDV system for authentication; and c) upon the first identification factor being approved by the EPCS module and the EPCS module receiving approval of the second identification factor from the third party IDV system, the EPCS module certifying the electronic prescription for transmission to the pharmacy system as a certified electronic prescription for the controlled substance.

In still another aspect, the invention can be an electronic prescription of controlled substances (EPCS) module residing on a wide area network, the EPCS module comprising programs configured to: (1) receive an electronic prescription for a controlled substance entered by a provider; (2) receive a first identification factor entered by the provider; (3) receive a second identification factor entered by the provider; (4) authenticate the first identification factor using a first identification factor database of an electronic prescription (EP) system; (5) transmit the second identification factor to a third party identification validation (IDV) system for authentication; (6) receive approval of the second identification factor from the third, party IDV system; (7) certify the electronic prescription upon the first identification factor being approved and approval of the second identification factor being received from the third party IDV system to create a certified electronic prescription; and (8) transmit the certified electronic prescription to a pharmacy system.

In another aspect, the invention can be a method for validating an identity of a provider for electronically prescribing a controlled substance on a wide area network, the wide area network comprising, in operable electronic communication, a health care provider (HCP) system, an electronic prescription (EP) system, and a third party identification validation (third party IDV) system, the method comprising: a) the EP system receiving a request that the provider be authorized for electronic prescription of controlled substances; b) the EP system receiving the provider's information; c) the EP system transmitting to the third party IDV system at least a portion of the provider's information and a request to deliver a second identifier to the provider; d) upon the provider receiving the second identifier and accessing an authentication interface of the EP system, the EP system displaying an application program interface (API) of the third party IDV system in the authentication interface of the EP system on the HCP system; e) the third party IDV system validating identity of the provider using data input into the displayed API by the provider, and transmitting identity validation approval to the EP system; f) upon receipt of the identity validation approval by the EP system, the provider establishing a first identification factor that is stored in the EP system; g) the provider inputting a second identification factor generated by the second identifier into the authentication interface of the EP system via the HCP system; g) transmitting the second identification factor to the third party IDV system; h) the third party IDV system authenticating the second identification factor and transmitting approval to the EP system; and i) upon receipt of the approval by the EP system, the EP system binding the second identifier to the provider and authorizing the provider for electronically prescribing controlled substances.

In yet another aspect, the invention can be a method for validating an identity of a provider for electronically prescribing a controlled substance comprising: a) storing in an electronic prescription (EP) system a first identification factor established by a provider upon successful completion of an identity validation process; b) a third party identification validation (third party IDV) system authenticating a second identification factor generated by a second identifier and supplied to the third party IDV system by the provider via the EP system, the second identification factor unknown by the EP system; and c) upon the EP system receiving an approval response from the third party IDV system indicating that the second identification factor is correct, the EP system validating the identity of the provider.

In still another aspect, the invention can be a method for a provider to electronically prescribe controlled substances comprising: an electronic prescription (EP) system validating identity of the provider and binding a second identifier to the provider using a third party identification vendor (IDV) system; the EP system receiving a controlled substance prescription from the provider; the EP system authorizing the provider using the third party IDV system; the EP system certifying the controlled substance prescription; the EP system electronically transmitting the certified controlled substance prescription to a health care provider (HCP) system; the HCP system receiving the certified controlled substance prescription and electronically transmitting the certified controlled substance prescription to a pharmacy system; and the pharmacy system receiving the certified controlled substance prescription.

In another aspect, the invention can be a method for a provider to electronically prescribe controlled substances comprising: an electronic prescription (EP) system validating identity of the provider and binding a second identifier to the provider using a third party identification vendor (IDV) system; the EP system receiving a controlled substance prescription from the provider; the EP system authorizing the provider using the third party IDV system; the EP system certifying the controlled substance prescription; the EP system electronically transmitting the certified controlled substance prescription to a pharmacy system; and the pharmacy system receiving the certified controlled substance prescription.

In still another aspect, the invention can be a method for binding a second identifier to a provider for the electronic prescription of controlled substances comprising: an electronic prescription (EP) system receiving an National Provider Identification (NPI) number of the provider and an addresses of the provider; the EP system confirming the NPI number of the provider in an NPI database; the EP system requesting a third party identification validation (IDV) system to deliver a second identifier to the provider's mailing address; the third party IDV system delivering the second identifier to the provider's mailing address; the provider receiving the second identifier; the provider logging into the EP system; the EP system using the third party IDV system to validate the provider's identity, wherein the third party IDV system: (1) verities the provider's credit information; (2) builds questions specific to the provider based on the provider's credit information; (3) transmits the questions to the provider via the EP system; (4) receives answers from the provider via the EP system; and (5) returns a verification to the EP system validating the provider's identity; the provider creating a first authentication factor using the EP system; the second identifier generating a second identification factor; the EP system receiving the second identification factor from the provider; the EP system transmitting the second identification factor to the third party IDV system for authentication; the third party IDV system transmitting an authentication signal to the EP system authenticating the second identification factor; and the EP system binding the second identifier to the provider.

In another aspect, the invention can be an electronic prescription of controlled substances (EPCS) module residing on a wide area network, the EPCS module comprising programs configured to: (1) receive a request that a provider be authorized for electronic prescription of controlled substances; (2) validate identity of the provider using a third party identification verification (third party IDV) system; (3) store a first identification factor determined by the provider in a first identification factor database of an electronic prescription (EP) system; (4) receive a second identification factor entered by the provider; (5) transmit the second identification factor to the third party identification validation (IDV) system for authentication; (6) receive approval of the second identification factor from the third party IDV system; and (7) authorize the provider for the electronic prescription of controlled substances.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic diagram of a system for electronically prescribing controlled substances according to one embodiment of the present invention;

FIG. 2 is a schematic diagram of a system for electronically prescribing controlled substances according to another embodiment of the present invention;

FIG. 3 is a schematic diagram of a system for electronically prescribing controlled substances according to yet another embodiment of the present invention;

FIG. 4 is a schematic diagram of a health care provider system according to one embodiment of the present invention;

FIG. 5 is a schematic diagram of an electronic prescription system according to one embodiment of the present invention;

FIG. 6 is a schematic diagram of a third party identification validation system according to one embodiment of the present invention;

FIG. 7 is a schematic diagram of a pharmacy system according to one embodiment of the present invention;

FIG. 8 is a schematic diagram of an electronic prescribing of controlled substances module according to one embodiment of the present invention;

FIG. 9 is a schematic diagram of an national provider identifier system according to one embodiment of the present invention;

FIGS. 10a-10e is a flow chart of an identification validation process of the electronic prescription of controlled substances module according to one embodiment of the present invention.

FIGS. 11a-11e is a flow chart of an electronic prescription process of the electronic prescription of controlled substances module according to one embodiment of the present invention.

FIG. 12 is a flow chart of an identification validation process of the electronic prescription of controlled substances module according to another embodiment of the present invention.

FIGS. 13a-13j are screen shots of an identification validation process of the electronic prescription of controlled substances module via a display device of a health care provider system according to one embodiment of the present invention.

FIG. 14 is a flow diagram of an electronic prescription process of the electronic prescription of controlled substances module according to another embodiment of the present invention.

FIG. 15 is a flow diagram of a provider activation process of a logical access control module of an electronic prescription of controlled substances module according to an embodiment of the present invention.

FIGS. 16a-16b are screen shots of a provider activation process of a logical access control module of the electronic prescription of controlled substances module via a display device of a health care provider system according to another embodiment of the present invention.

FIG. 17 is a flow diagram of the electronic prescription of controlled substances module processing an electronic prescription for a controlled substance according to an embodiment of the present invention.

FIG. 18 is a flow diagram of the electronic prescription of controlled substances module processing an electronic prescription for a controlled substance according to another embodiment of the present invention.

FIG. 19a-19c are screen shots of the electronic prescription of controlled substances module processing an electronic prescription for a controlled substance via a display device of a health care provider system according to an embodiment of the present invention.

### DETAILED DESCRIPTION OF THE INVENTION

The following description of the preferred embodiment(s) is merely exemplary in nature and is in no way intended to limit the invention, its application, or uses.

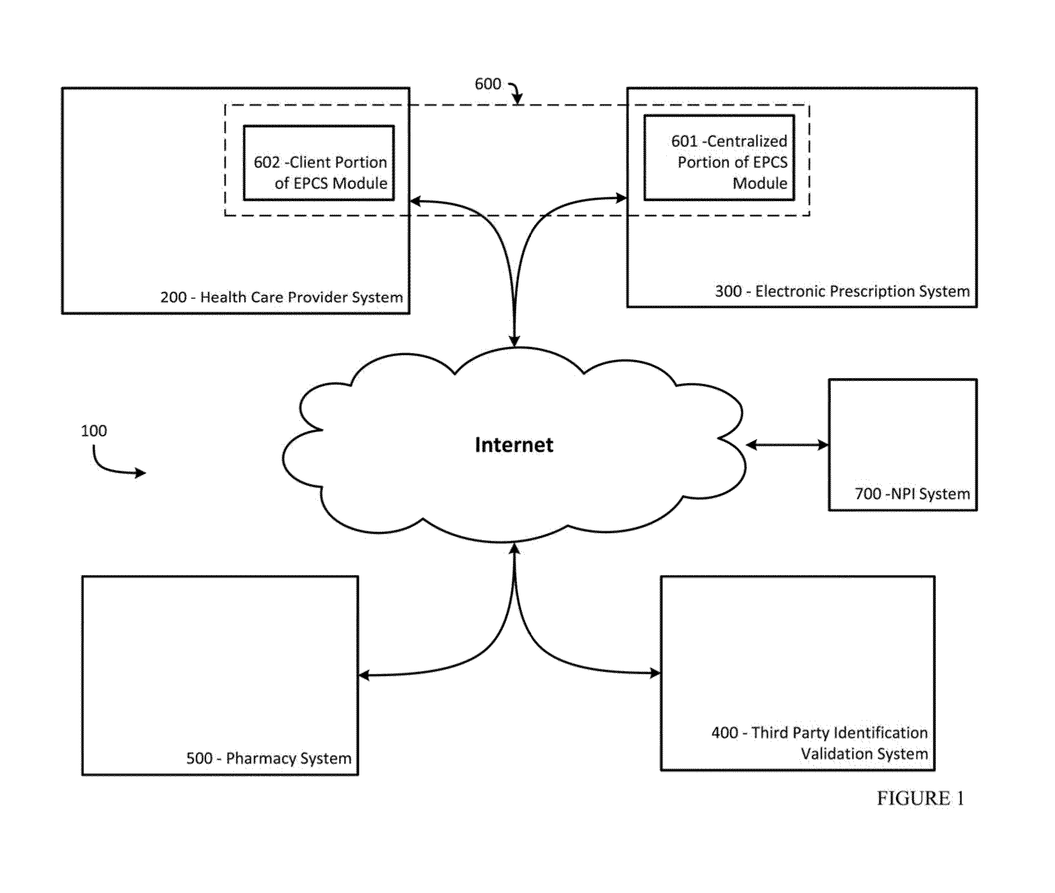

Referring to FIG. 1, a schematic diagram of a system 100 for electronically prescribing controlled substances according to one embodiment of the present invention is illustrated. Generally, the system 100 comprises a health care provider (HCP) system 200, an electronic prescription (EP) system 300, a third party identification vendor (third party IDV) system 400, a pharmacy system 500, an electronic prescription of controlled substances (EPCS) module 600 and a National Provider Identifier (NPI) system 700 all in operable communication with one another to form a wide area network (WAN).

As exemplified by FIG. 1, the components of the system 100 are in operable communication via the internet. However, the invention is not so limited and other electronic communication means may be utilized, such as a satellite network, a cellular network, a common carrier network(s), Wi-Fi, WiMAX or any combination thereof. Further, it should be noted that operable communication includes any means of electronic communication, such as but not limited to wired and wireless electronic communication, in which data can be transmitted and received between the systems and modules of the system 100. Moreover, it should also be noted that operable, communication includes both direct and indirect communication, as well as bi-directional communication between the systems and modules of the system 100.

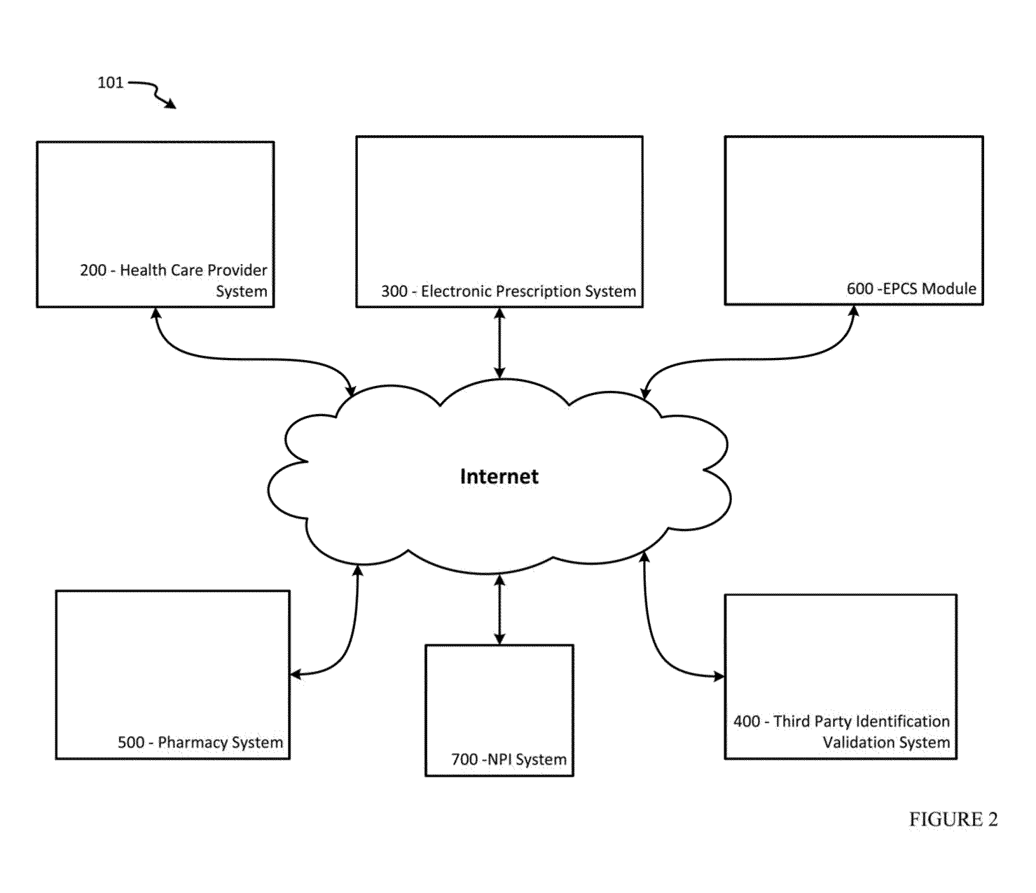

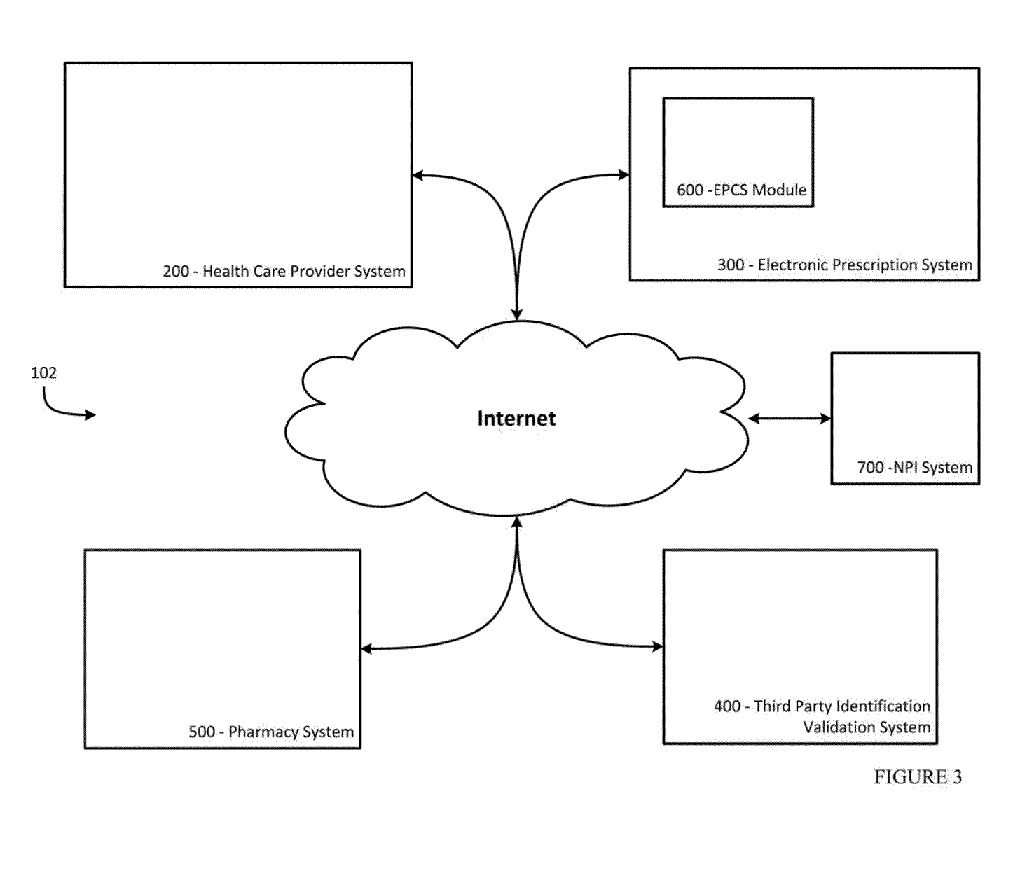

As discussed in more detail below, the system 100 of the present invention may be configured in other ways. For instance, FIGS. 2 and 3 illustrate two alternate embodiments of the system 100. Nonetheless, it should be noted that the invention is not limited only to those configuration explicitly described herein, and the system 100 may take on other configurations and layouts.

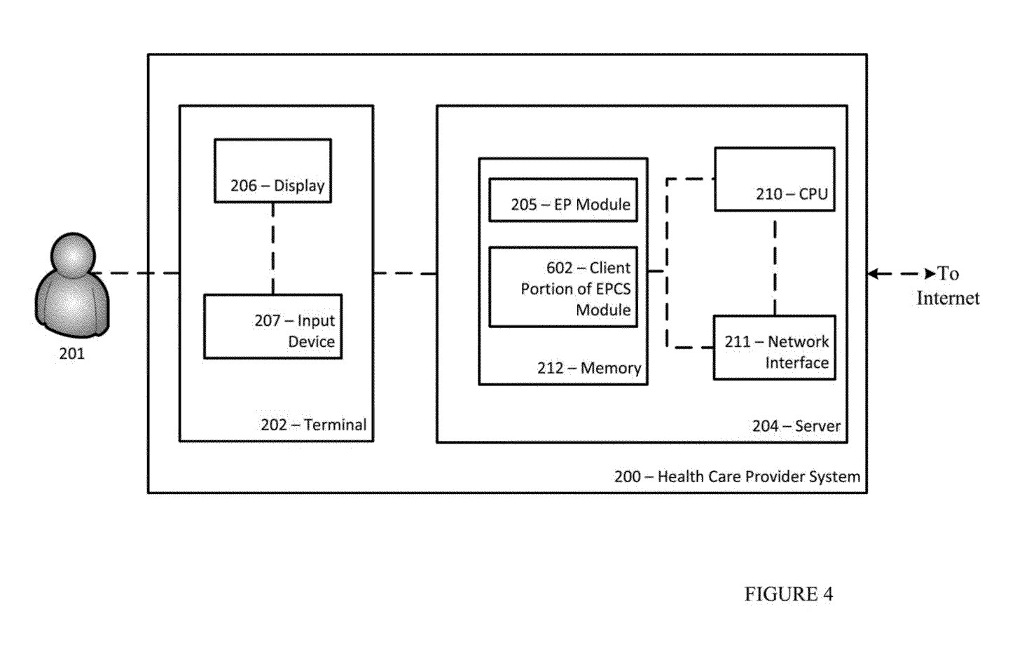

Referring to FIG. 4, a schematic diagram of an HCP system 200 according to one embodiment of the present invention is illustrated. The HCP system 200 comprises a terminal 202 and a server 204 in operable communication. Further, as discussed in more detail below, the HCP system 200 may also be said to comprise at least one health care provider 201. Although exemplified as comprising the above components, the HCP system 200 may comprise any number, more or less, of the components listed above. For example, a particular HCP system 200 may comprises a plurality of providers 201, a plurality of terminals 202 and/or a plurality of servers 204.

Generally, the HCP system 200 is an institution or organization that provides general and/or specific health care for those in need. For example, an HCP system 200 may be an entire hospital or a health care system, a specialized practice group within a larger hospital or health care system, a private general practice, or a private specialized practice. The provider 201 may be a medical doctor, a nurse practitioner or a staff administrator who is authorized to issue prescriptions. As noted above, the HCP system 200 may comprise any number of providers 201, and a particular provider 201 may be associated with more than one HCP system 200 at any given time.

The terminal 202 of the HCP system 200 may be a personal computer (PC) or a mobile electronic unit. Each terminal 202 of the HCP system 200 comprises a properly programmed processor (not shown), a memory device (not shown), a power supply (not shown), a video card (not shown), a display device 206, firmware (not shown), software (not shown), a network interface (not shown) and a user input device 207 (e.g., a keyboard, mouse and/or touch screen). Although not exemplified, it should be understood that the processor of the terminal 202 can have integrated memory. The properly programmed processor of the terminal 202 is configured to effectuate the processes and functions described below, including, but not limited to the effectuation of the graphical user interfaces (GUI) for display on the display device 206 of the terminal 202 for the provider 201 and the transmission of user inputs from the provider 201 via the input device 207 to the other systems and modules of the system 100.

The server 204 of the HCP system 200 comprises a properly programmed processor 210, a network interface 211, and a memory device 212 all in operable communication. It should be noted the processor 210 may be considered the processor of the HCP system 200. Further, although exemplified as a singe server 204, the invention is not so limited and the HCP system 200 may comprise any number of servers 204. Additionally, although not exemplified, it should be understood that the processor 210 can have integrated memory. The properly programmed processor 210 of the HCP system 200 effectuates the performing of the processes and functions described below, including but not limited to, the storage of data to the memory 212 of the HCP system 200, the performance of the processes and functions of the EP module 205 and the client portion of the EPCS module 602, and the transfer (transmission and receipt) of data from HCP system 200 to the other systems and modules of the system 100.

In the exemplified embodiment, the memory 212 comprises an electronic prescription (EP) module 205 and a client portion of the EPCS module 602. Although exemplified as part of the memory 212, in other embodiments the EP module 205 may reside elsewhere on the HCP system 200 or on another system altogether. Further, as discussed in more detail below, in other embodiments of the present invention, the client portion of the EPCS module 602 may reside elsewhere on the system 100 or be combined with the centralized portion of the EPCS module 601. Although exemplified as a single memory unit, it should be noted that the memory 212 may comprise any number of databases used to store data, modules, or other information. For example, the memory may be used to store general provider information, patient information, and appropriate software to allow the provider 201 to interact with the EP module 205 and the EPCS module 600.

The EP module 205 is one or more computer programs configured to allow a provider 201 to generate and transmit electronic prescriptions (although not necessarily electronic prescriptions for controlled substances). Although exemplified within the memory 212, in other embodiments the EP module 205 resides partially or entirely on one or more terminals 202 of the HCP system 200. Further, according to one embodiment, the EP module 205 may reside partially on the HCP system 200 (e.g., a thin client portion of the EP module 205) and the rest of the EP module 205 may reside on another system altogether. One non-limiting example of an EP module 205 is Rcopia® by DrFirst®.

As discussed in more detail below, after the provider 201 generates a prescription for a controlled substance using the EP module 205, using a terminal 202 (and via the HCP system 200) the electronic prescription is transmitted to the EPCS module 600 for processing. As also described in more detail below, the provider 201 interacts with the EP module 205 to generate and transmit an electronic prescription for a controlled substance to a pharmacy system 500 via the EPCS Module 600. Typically, the transmission of the electronic prescription is accomplished using the server 204 of the HCP system 200. However, the invention is not so limited and in alternate embodiments the transmission may be directly from the terminal 202 to the EPCS module 600.

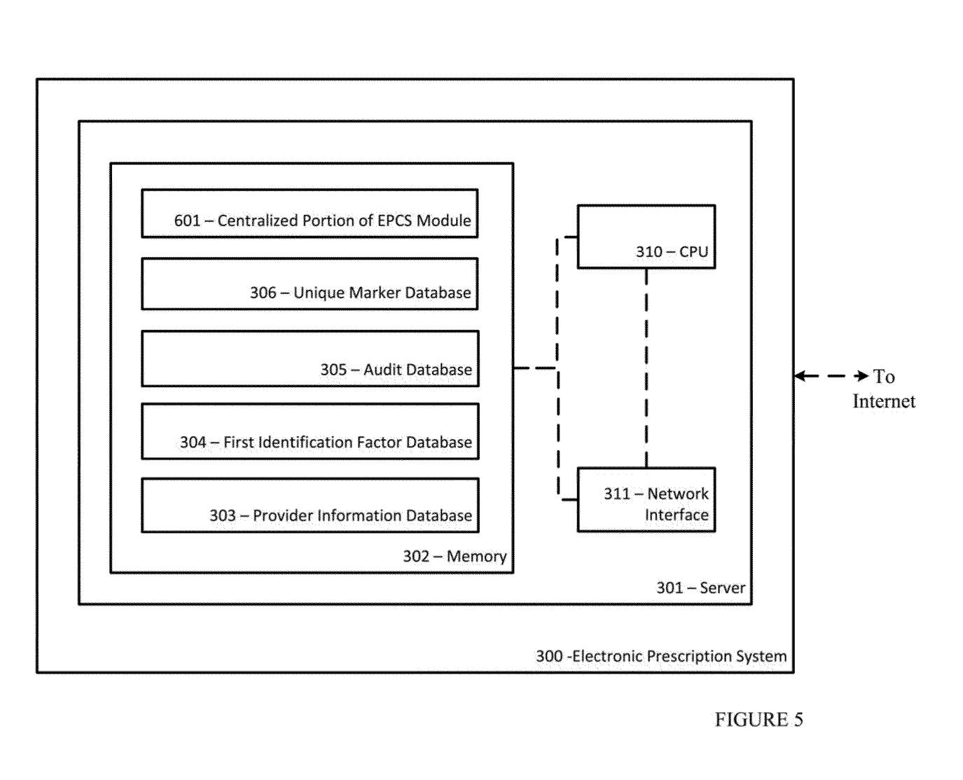

Referring to FIG. 5, a schematic diagram of an Electronic Prescription (EP) system 300 according to one embodiment of the present invention is illustrated. Generally, the EP system 300 comprises a server 301 which comprises a properly programmed processor 210, a network interface 211, and a memory unit 302 in operable communication. The processor 210 of the EP system 300 effectuates the performance of the processes and functions described herein, including but not limited to the association of data, the storage of data to the databases 303, 304, 305, and 306 of the memory 302, and the transfer of data between the EP system 300 and the other systems and modules of the system 100. Further, although exemplified as a singe server 301, the invention is not so limited and the EP system 300 may comprise any number of servers 301.

In the exemplified embodiment, the memory 302 of the EP system 300 comprises a provider information database 303, a first identification factor database 304, an audit database 305, a unique marker database 306, and a centralized portion of the EPCS module 601. As discussed above, and described in more detail below, in alternate embodiments the centralized portion of the EPCS module 601 may reside elsewhere on the system 100 or be combined with the client portion of the EPCS module 602.

The provider information database 303 stores the provider's general information, such as but not limited to, the provider's name, address, date of birth, phone number, driver's license, National Provider Identifier (NPI) number, Drug Enforcement Administration (DEA) number, DEA state, the provider's associated HCP system(s) 200, or any combination thereof. The first identification factor database 304 stores a list of authorized providers 201 along with their first identification factor, the name of their second identifier(s) and the unique marker(s) of their second identifier(s). As discussed in more detail below, the first identification factor database 304 is used by the EPCS module 600 when authenticating a provider 201 for an electronic prescription of a controlled substance.

The audit database 305 stores the records of all processes and transactions that occur using the EPCS module 600. For example, the audit database 305 stores copies of all electronic prescriptions of controlled substances (including the associated digital signatures and certification indicators) that are processed by the EPCS module 600, all records of authorized providers 201 (including their associated HCP system(s) 200 and their associated NPI number), and all access control changes made by the EPCS module 600 for each provider 201 and HCP system 200. The unique marker database 306 stores a list of authorized providers 201 with the unique markers of their second identifiers. As discussed in more detail below, the unique marker database 306 is used by the EPCS module 600 when authenticating a provider 201 for an electronic prescription of a controlled substance.

While a single memory 302 is exemplified it should be noted that the EP system 300 is not so limited, and in alternate embodiments EP system 300 may comprise any number of memory units and/or databases. Further, the invention is not limited to the location of the databases of the memory 302, and in alternate embodiments the databases 303, 304, 305, and 306 may reside anywhere on the system 100. Furthermore, according to one embodiment, the EP system 300 further comprises at least one terminal (e.g. a PC and/or a mobile electronic unit (not shown)) to allow for the effectuation of the processes and functions described herein.

Further, it should be noted that in one embodiment, the provider information database 303 further comprises additional provider information, such as, but not limited to the provider's social security number and credit card information. However, as discussed in more detail below and according to one embodiment of the present invention, the EPCS module 600 receives the provider's social security number, date of birth, driver's license information and credit card information via an API of the third party IDV system 400 and transmits that provider information to the third party IDV system 400 without ever permanently saving the information in the memory 302 of the EP system 300.

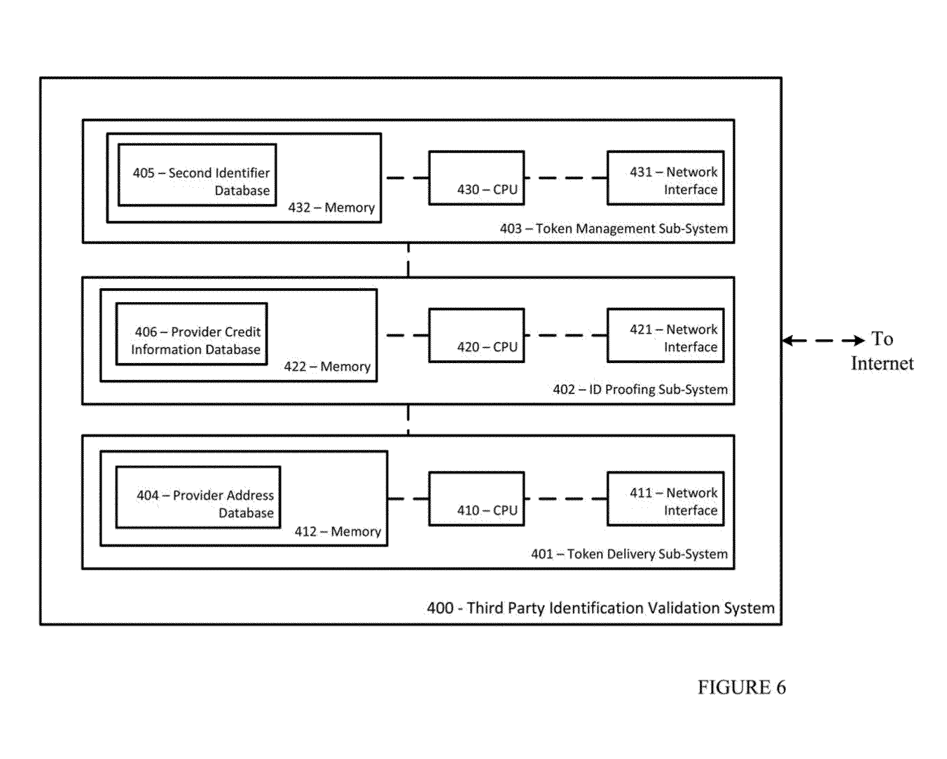

Referring to FIG. 6, a schematic diagram of a third party IDV system 400 according to one embodiment of the present invention is illustrated. The third party IDV system 400 is configured to authorize a provider 201 to use the EPCS module 600 to electronically prescribe controlled substances (by validating the identity of the provider 201) and to authenticate the provider 201 each time they use the EPCS module 600 to process an electronic prescription tier a controlled substance. The third party IDV system 600 comprises a token delivery sub-system 401, an identification (ID) proofing sub-system 402 and a token management sub-system 403, all in operable communication.

The token delivery sub-system 401 comprises a properly programmed processor 410, a network interface 411, and a memory unit 412. Similarly, the ID proofing sub-system 402 comprises a properly programmed processor 420, a network interface 421, and a memory unit 422. Moreover, the token management sub-system 403 also comprises a properly programmed processor 430, a network interface 431, and a memory unit 432. The processors 410, 420, 430 of the third party IDV system 400 effectuates the performance of the processes and functions described herein, including but not limited to the storage of data to the databases 404, 405, 406, the generation of identification proofing questions, the delivery a the second identifier, the validation of a second identification factor, and the transfer of data between the third party IDV system 400 and the other systems and modules of the system 100.

As discussed in more detail below, the token delivery sub-system 401 is configured to deliver a second identifier to a provider 201 in response to a request generated by the EPCS module 600 and received by the token delivery sub-system 401. As also discussed in more detail below, prior to the provider 201 being authorized by the EPCS module 600 to electronically prescribe controlled substances, the token delivery sub-system 401 first delivers a second identifier (which is in one embodiment a token) to the individual provider 201. Delivery of the second identifier may be accomplished via a courier service (e.g., the United States Postal Service), electronic mailing (email), or the transmission of a downloadable application.

In the exemplified embodiment, the memory 412 of the token delivery sub-system 401 comprises a provider address database 404. The provider address database 404 stores the addresses (physical and/or email) of each provider 201 invited to use the EPCS module 600 and/or authenticated by the EPCS module 600 to electronically prescribe controlled substances. As described in more detail below, the second identifier is used to authenticate the provider 201 each time they would like to electronically prescribe a controlled substance.

The identification (ID) proofing sub-system 402 is configured to validate the identity of the provider 201 prior to authorizing the provider 201 to use the EPCS module 600 to electronically prescribe controlled substances. The memory 422 of the ID proofing sub-system 402 comprises a provider credit information database 406 and computer programs that are configured to generate questions for a specific provider 201 based on received provider information. The provider credit information database 406 stores provider information such as the credit information of the providers 201.

According to one embodiment, and as described in more detail below, the ID proofing sub-system 402 receives information relating to a provider 201 from the EPCS module 600 and generates questions specific to that provider 201. For instance, according to one embodiment, the ID proofing sub-system 402 receives the provider's full name, social security number, and credit card information, runs a credit report on the provider 201 and generates questions based off the provider's credit report. Next, the questions are displayed by the EPCS module 600 via a third party application programming interface (API) on the display device 206 and answers to the questions are received by the EPCS module 600 from the provider 201 and routed to the third party IDV system 400. Thereafter, the ID proofing sub-system 402 receives answers from the provider 201 regarding those questions via the EPCS module 600. If the provider's answers reach a required threshold of accuracy (e.g., the provider 201 answers all the questions correctly), then the identity of the provider 201 is validated by the ID proofing sub-system 402 and, thus the provider 201 may be authorized to use the EPCS module 600 to electronically prescribe controlled substances.

Of course, it should be noted that the invention is not so limited, and the ID proofing sub-system 402 may generate questions based on any combinations of the provider's information and may do so using any means, including but not limited to running a credit check. Stated simply, the present invention is not limited to the means or criteria by which the ID proofing sub-system 402 validates the identity of the provider 201 for the EPCS module 600.

As discussed in more detail below, the token management sub-system 403 is configured to receive second identification factors and authenticate the second identification factors during a multi-factor identification authentication process of the EPCS module 600. In the exemplified embodiment and as discussed in more detail below, the token management sub-system 403 comprises a second identifier database 405 and the server of the token management sub-system 403 comprises an algorithm(s) that is configured to authenticate second identification factors provided by providers 201 via the EPCS module 600.

The second identifier database 405 is stored within the memory 432 of the token management sub-system 403 and stores information relating to each of the second identifiers (e.g., the unique markers for each issued second identifier) issued to the providers 201. As discussed in more detail below, the algorithm(s) uses the unique marker (e.g., a serial number) of a second identifier and the time the second identifier generated the second identification factor (e.g., a time stamp) to confirm that the second identification factor received by the token management sub-system 403 is accurate.

Although exemplified as three separate sub-systems, in one embodiment of the present invention two or more of the token delivery sub-system 401, the ID proofing sub-system 402, and the token management sub-system 403 may be part of the same system. Further, each of the sub-systems may be run by separate third party identification validation vendors or two or more of the sub-systems may be run by the same party identification validation vendor.

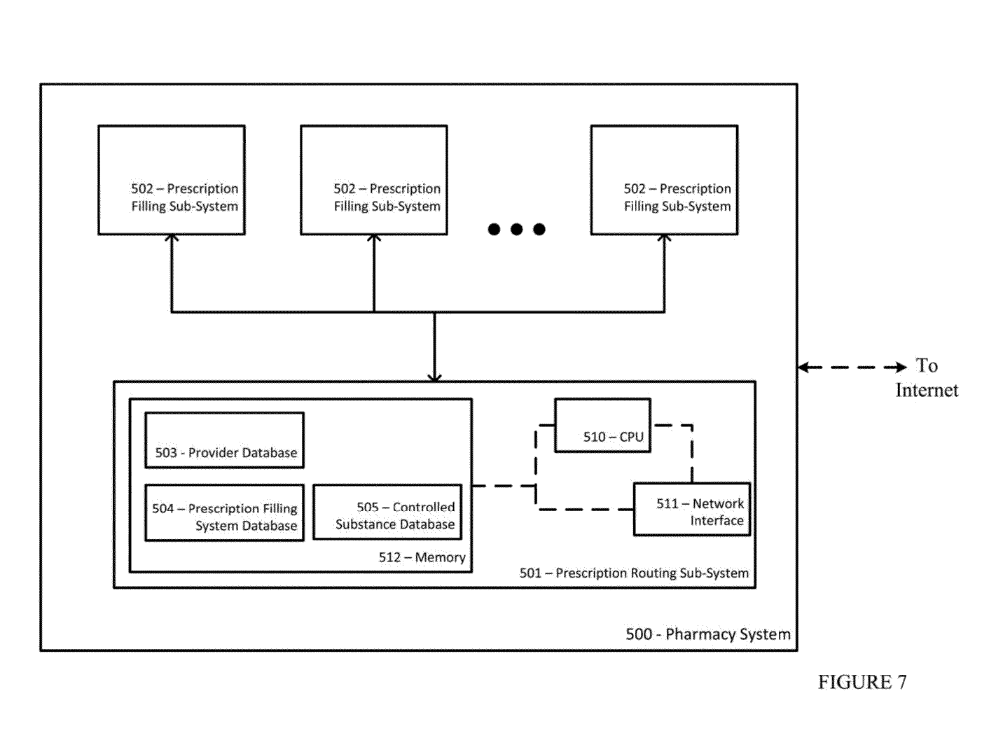

Referring to FIG. 7, a schematic diagram of a pharmacy system 500 according to one embodiment of the present invention is illustrated. In the exemplified embodiment, the pharmacy system 500 comprises a prescription routing sub-system 501 and at least one prescription filling sub-system 502, all in operable communication with one another. The prescription routing sub-system 501 comprises a properly programmed processor 510, a network interface 511, and a memory device 512. Although not exemplified, each of the prescription filling sub-systems 502 comprises a properly programmed processor, a network interface, and a memory unit. The processors 510 of the pharmacy system 500 effectuate the processes and functions described herein, including but not limited to, the transfer of data between the pharmacy system 500 and the other systems and modules of the system 100.

As discussed in more detail below, the prescription routing sub-system 501 is configured to electronically receive a prescription for a controlled substance from the EPCS module 600 and route the prescription to a prescription filling sub-system 502. In some embodiments and as also discussed in more detail below, the prescription routing sub-system 501 is further configured to confirm the schedule of the substance listed on the prescription and confirm that the prescription filling system 502 identified on the prescription is capable of receiving electronic prescriptions for controlled substances. Stated simply, the prescription routing sub-system 501 is configured to route authorized prescriptions for controlled substances from the EPCS module 600 to at least one of the prescription tilling sub-systems 502.

In the exemplified embodiment, the prescription routing sub-system 501 comprises a provider database 503, a prescription filling system database 504, and a controlled substance database 505. The provider database 503 stores the names and information of all providers 201 authorized to electronically prescribe controlled substances. The prescription filling system database 504 stores the names, addresses and other information relating to each of the prescription filling sub-system(s) 502. Finally, the controlled substance database 505 stores a list of all controlled substances, as opposed to legend drugs, which may be electronically prescribed by the pharmacy system 500. Although exemplified as three separate databases, it should be understood that any or all of the databases may be combined in alternate embodiments.

The prescription filling sub-system 502 is a system that fills the prescribed substance for an end user. For example, prescription filling sub-system 502 may be a local pharmacy used by the end user.

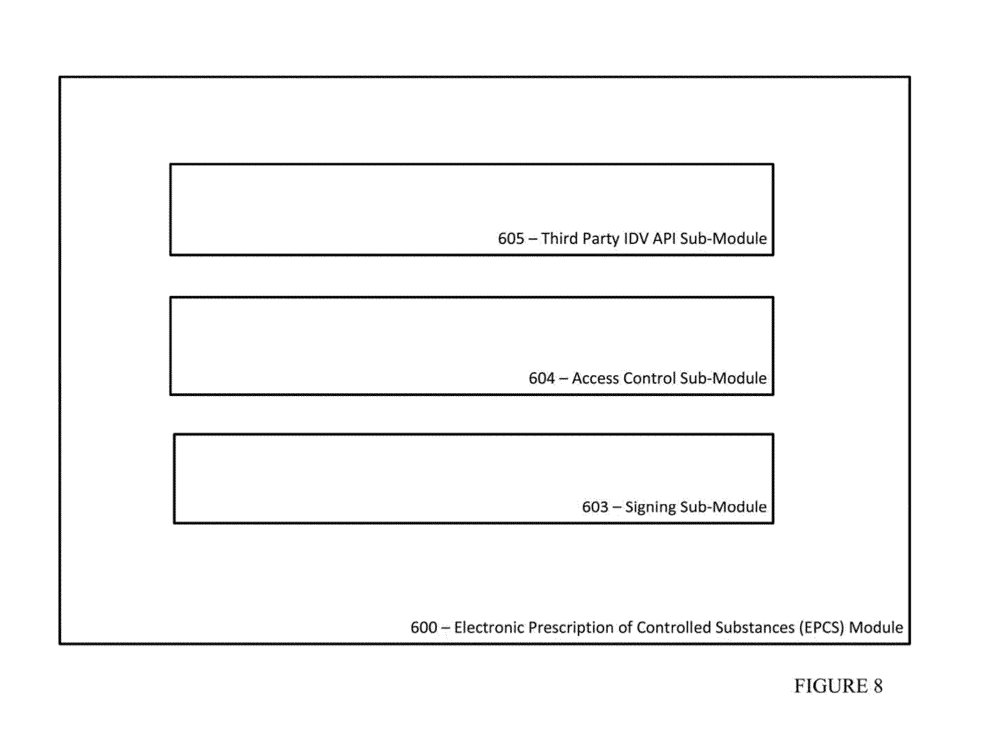

Referring to FIG. 8, a schematic diagram of an EPCS module 600 according to one embodiment of the present invention is illustrated. As discussed in more detail below, the EPCS module 600 is one or more computer programs configured to: (1) authorize providers 201 to electronically prescribe controlled substances; (2) receive requests to electronically prescribe controlled substances from authorized providers 201; (3) confirm the accuracy of information as it relates to providers 201, controlled substance prescriptions and pharmacy systems 500; and (4) route electronic prescriptions of controlled substances from an authorized provider 201 to a pharmacy system 500.

As discussed above with reference to FIGS. 1-3, the EPCS module 600 may reside on more than one system of the system 100. For example and as exemplified in FIG. 1, the EPCS module 600 may comprise a centralized portion 601 that resides on the EP system 300 and a client portion 602 that resides on the HCP system 200. Further, in another embodiment and as exemplified in FIG. 2, the EPCS module 600 may be a part of its own, separate system of the system 100. Moreover, in yet another embodiment and as exemplified in FIG. 3, the EPCS module 600 may reside entirely on the EP system 300. Nonetheless, it should be noted that the invention is not so limited and in other embodiments, the entirety of the EPCS module 600 may reside on any system of the system 100, may be broken down into more than just two portions, or have portions residing on other systems of the system 100.

Since the EPCS module 600 may reside on more than one system (e.g., FIG. 1) or may reside entirely one system of the system 100 (e.g., the embodiments shown in FIGS. 1 and 3), the EPCS module 600 is stored within the memory of that system(s) and uses the processor(s), memory, hardware, software, firmware and network interfaces of that system(s) to perform the tasks and processes described in more detail below. If the EPCS module 600 is part of its own, separate system (e.g., FIG. 2), then that system comprises a server that comprises at least one properly programmed processor, hardware, software, firmware, memory and network interface, all in operable communication with one another, and which enables the EPCS module 600 to perform the tasks and processes described below.

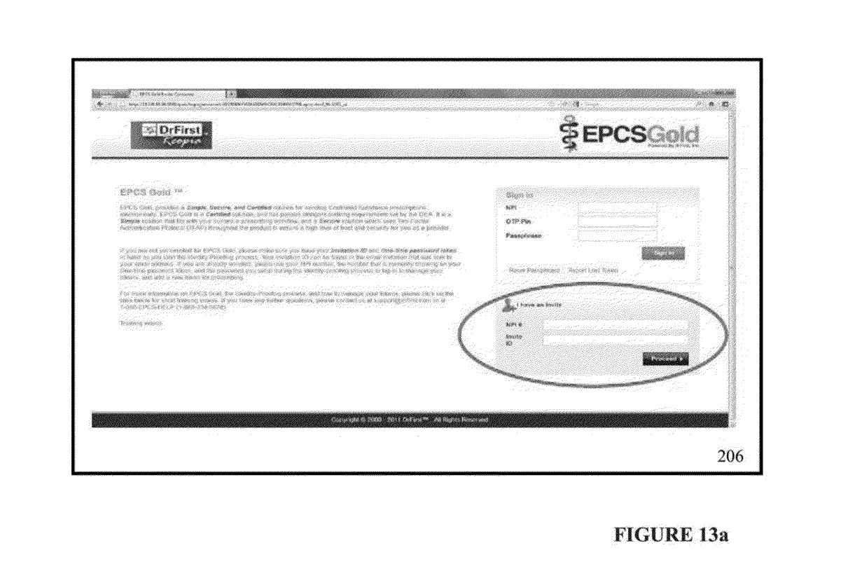

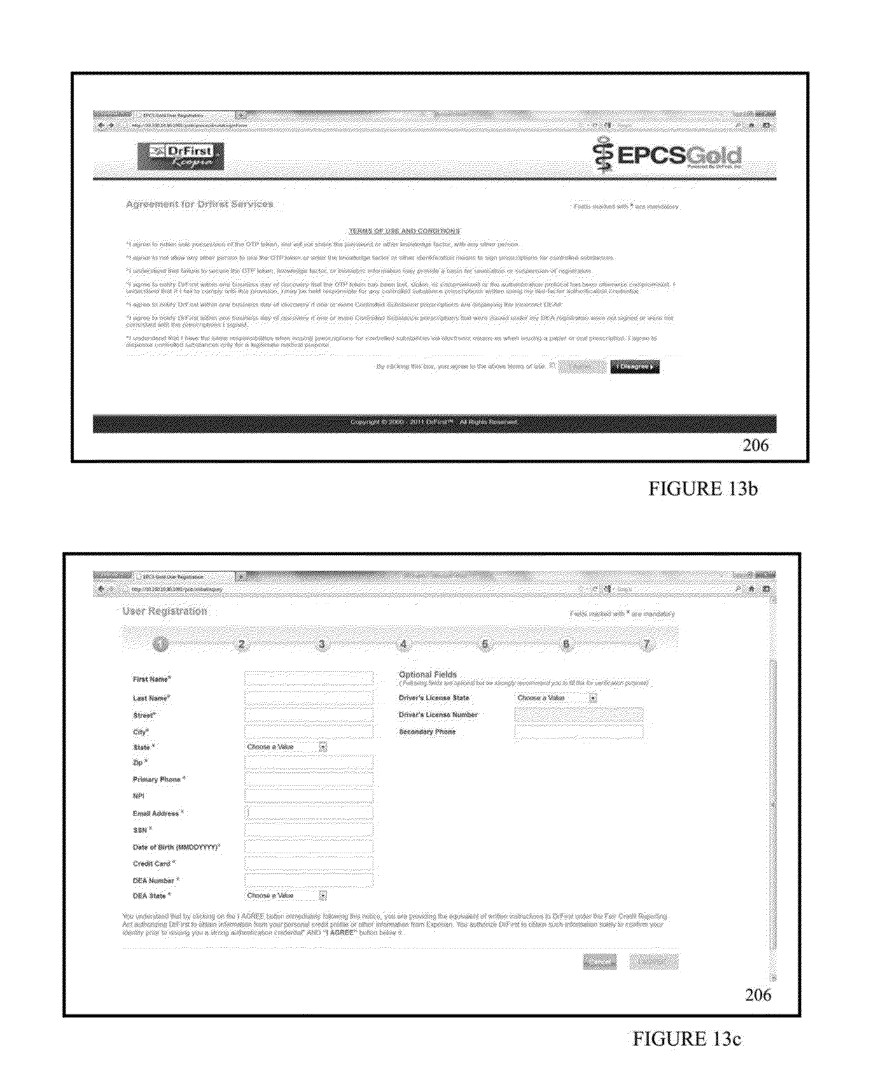

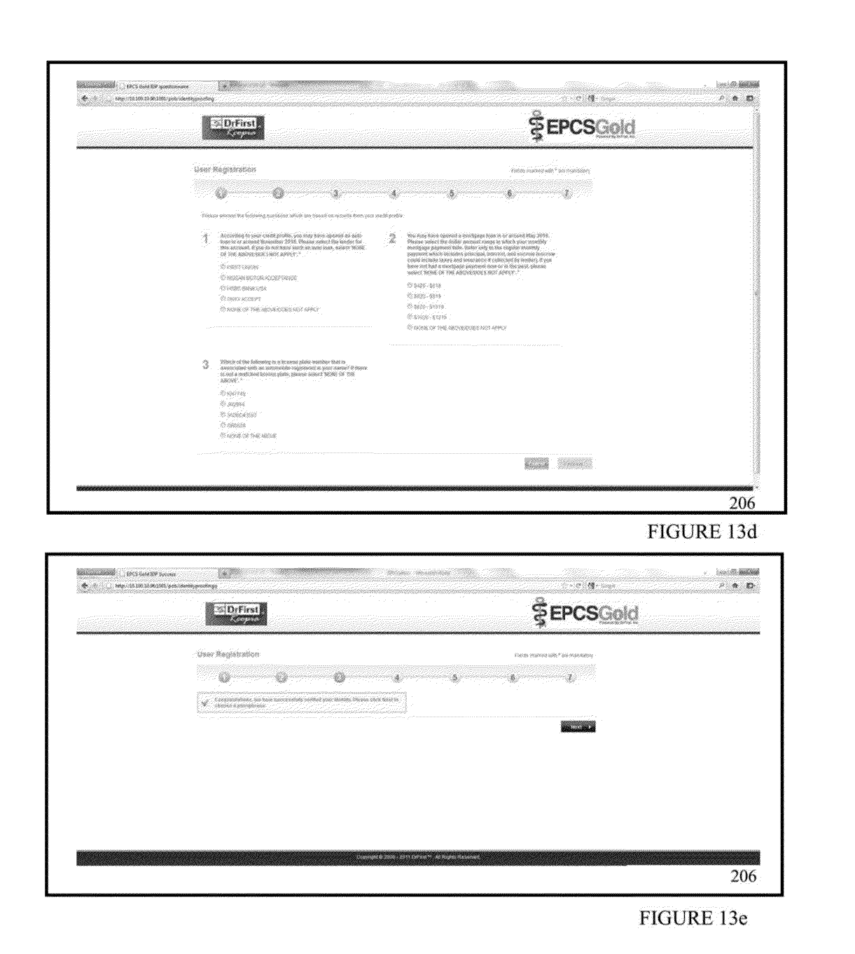

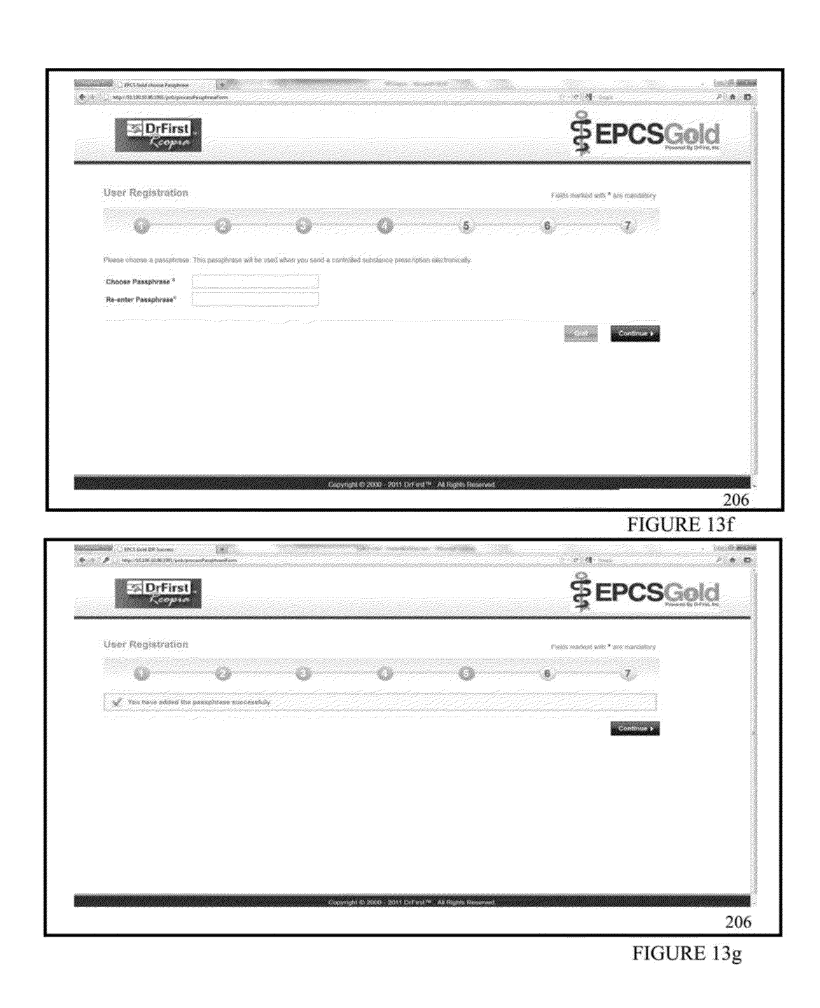

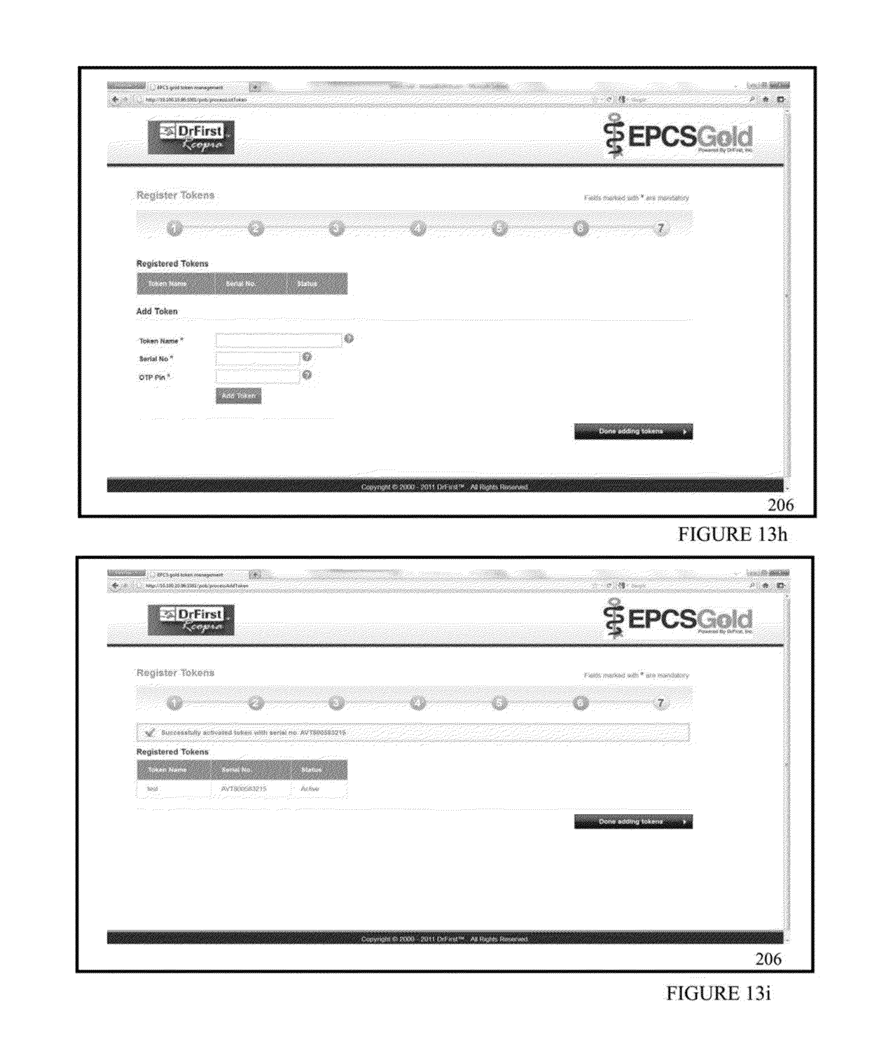

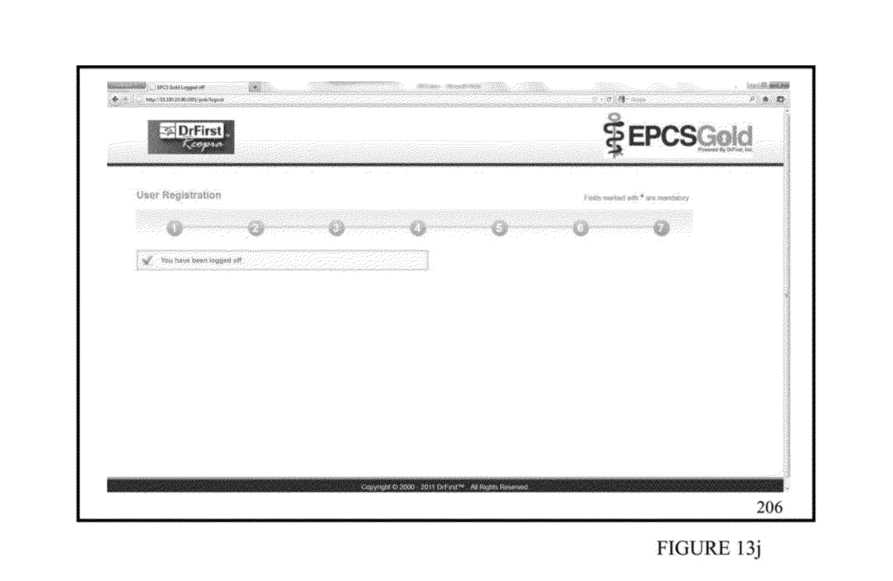

Moreover and as discussed in more detail below, the EPCS module 600 generates the interfaces described herein that are displayed on the display devices 206 of the terminals 202 of the HCP system 200. A provider 201 interacts with the interfaces generated by the EPCS module 600 using the input devices 207 of the terminals 202 of the HCP system 200. Therefore, the provider's input to or interaction with the EPCS module 600 via the input devices 207 of the terminals 202 of the HCP system 200 is used to effectuate additional processing by the EPCS module 600, the HCP system 200, and/or any other systems or modules of the system 100 as described herein. For example, the screen shots illustrated in FIGS. 13a-13j, 16a-16b, and 19a-19c are examples of interfaces generated by the EPCS Module 600 and displayed on the display devices 206 of the terminals 202 of the HCP system 200.

In embodiments where the EPCS module 600 comprises a centralized portion 601 and a client portion 602, the centralized portion 601 is configured to do most of the heavy processing of the EPCS module 600. Further, in such embodiments, the client portion 602 is a thin-client portion that resides on the HCP system 200 and enables an interface and light processing for provider 201 at their terminal 202. Further, according to one embodiment of the present invention, the client portion 602 of the EPCS module 600 may be a data acquisition and routing portion, such as a prescription routing portion of the EPCS module 600. In such embodiments, the client portion 602 resides on an external system (e.g., the HCP system 200) and is configured to route a certified electronic prescription for a controlled substances from the centralized portion 601 of the EPCS module 600 to the pharmacy system 500.

As exemplified in FIG. 8 and according to one embodiment of the present invention, regardless of the residence of the EPCS module 600, the EPCS module 600 comprises a signing sub-module 603, an access control sub-module (ACM) 604, and a third party IDV application programming interface (API) sub-module 605. According to one embodiment, each of the third party IDV API sub-module 605, the ACM 604 and the signing sub-module 603 comprises at least one computer program that is configured to perform the tasks and processes described for that sub-module in more detail below.

According to one embodiment of the present invention and as discussed in more detail below, the third party IDV API sub-module 605 is a gateway or portal between the EPCS module 600 and the third party IDV system 400. In embodiments, where the EPCS module 600 comprises a centralized portion 601 and a client portion 602, the third party IDV API sub-module 605 may be resident on either the centralized portion 601 or the client portion 602 of the EPCS module 600. As discussed in more detail below, the third party IDV API sub-module 605 may be used for, among other things, the identity proofing process of the ID proofing sub-system 402.

According to one embodiment of the present invention and as discussed in more detail below, the ACM 604 is used to grant access to the EPCS module 600 for an authorized provider 201. Further, the signing sub-module 603 is used by the EPCS module 600 to process an electronic prescription request for a controlled substance from an authorized provider 201.

According to one embodiment of the present invention, the EPCS module 600 comprises the EP module 205. In other words, the functions of the EP module 205 and the functions of the EPCS module 600 can be integrated into a single software package. Therefore, in such embodiments, the provider 201 may use the EPCS module 600 to create and fill out electronic prescriptions, as well as electronically transmit the prescriptions to the pharmacy system 500. Further, in such embodiments, the integrated EP module/EPCS module may take form of any of the resident configurations described above.

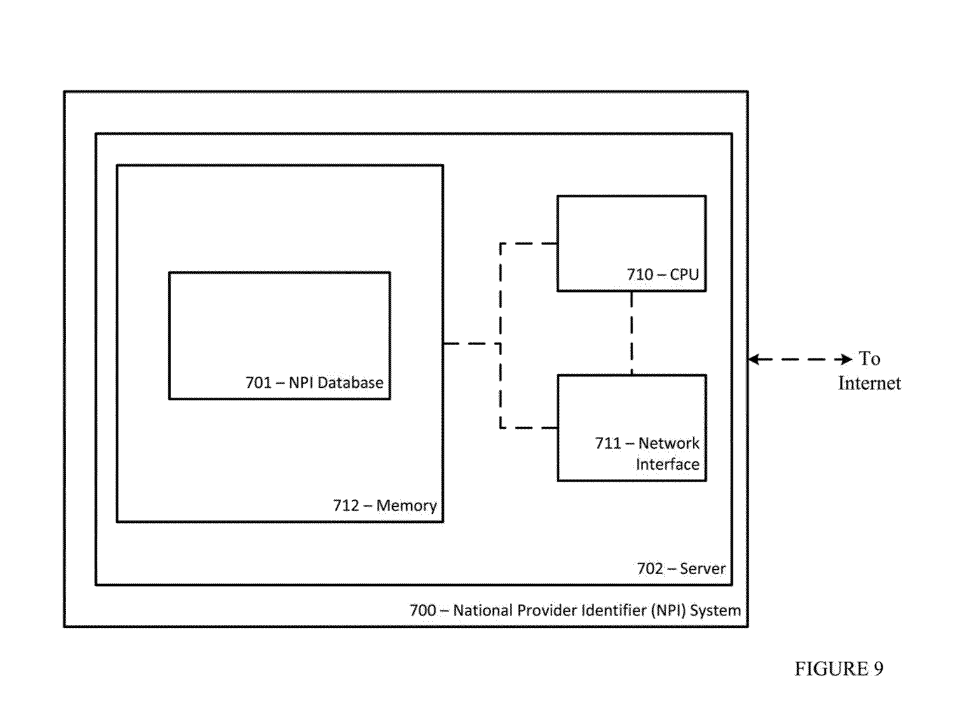

Finally, referring to FIG. 9, a schematic diagram of a National Provider Identifier (NPI) system 700 according to one embodiment of the present invention is illustrated. As discussed in more detail below, the NPI system 700 is configured to confirm a provider's NPI number for the EPCS module 600. According to the exemplified embodiment, the NPI system 700 comprises a server 702 which comprises a properly programmed processor 710, a network interface 711, and a memory unit 712, in operable communication with one another. The processor 710 of the NPI system 700 effectuates the performance of the processes and functions described herein, including but not limited to, the transfer of data between the NPI system 700 and the other systems and modules of the system 100. Further, the memory 712 comprises an NPI database 701 that stores records for all providers 201 who are authorized by the Centers for Medicare and Medicaid Services (CMS) to prescribe controlled substances.

Generally and in accordance with one embodiment of the present invention, a method for electronically prescribing controlled substances using the EPCS module 600 generally comprises three steps: (1) authorizing a provider 201; (2) granting an authorized provider 201 access to the EPCS module 600; and (3) processing an electronic prescription request from an authorized provider 201 for a controlled substance.

As described in detail below, the EPCS module 600 authorizes a provider 201 using multiple resources, such as a third party IDV system 400, to validate the provider's identity and right to prescribe controlled substances. The process of authorizing a provider 201 to electronically prescribe controlled substances is part of the initial registration process of a provider 201 for the EPCS module 600. Specifically, the authorization process is accomplished by having a provider 201 complete an identity proofing process and establish the multiple factors of a multi-factor identification authentication process. The identity proofing process is a process by which the EPCS module 600 validates the provider's identity using the third party IDV system 400. As discussed in more detail below, in the exemplified embodiment the multi-factor identification authentication process is a two-factor authentication process, whereby the first factor is something the provider 201 “knows” (e.g., a passphrase) and the second factor is something the provider 201 “has” (e.g., a second identification factor generated by a token or a biometric of the provider 201). However, as is discussed in more detail below, the invention is not so limited and the multi-factor identification authentication process may comprise more than two factors and/or the factors may be different from those explicitly described herein.

Generally, the step of granting an authorized provider 201 access to the EPCS module 600 comprises an administrator of a HCP system 200 granting access to a provider 201 to electronically prescribe controlled substances via a particular HCP system 200. Finally, the step of processing an electronic prescription for a controlled substance comprises the EPCS module 600 receiving a request for an electronic prescription of a controlled substance, the provider's first identification factor and a second identification factor of the provider 201. Thereafter, the EPCS module 600 authenticates the first identification factor and transmits the second identification factor (along with a time stamp) to a third party IDV system 400 for authentication. Finally, the EPCS module 600 certifies the electronic prescription for a controlled substance and transmits the certified electronic prescription to a pharmacy system 500.

1. Authorizing a Provider

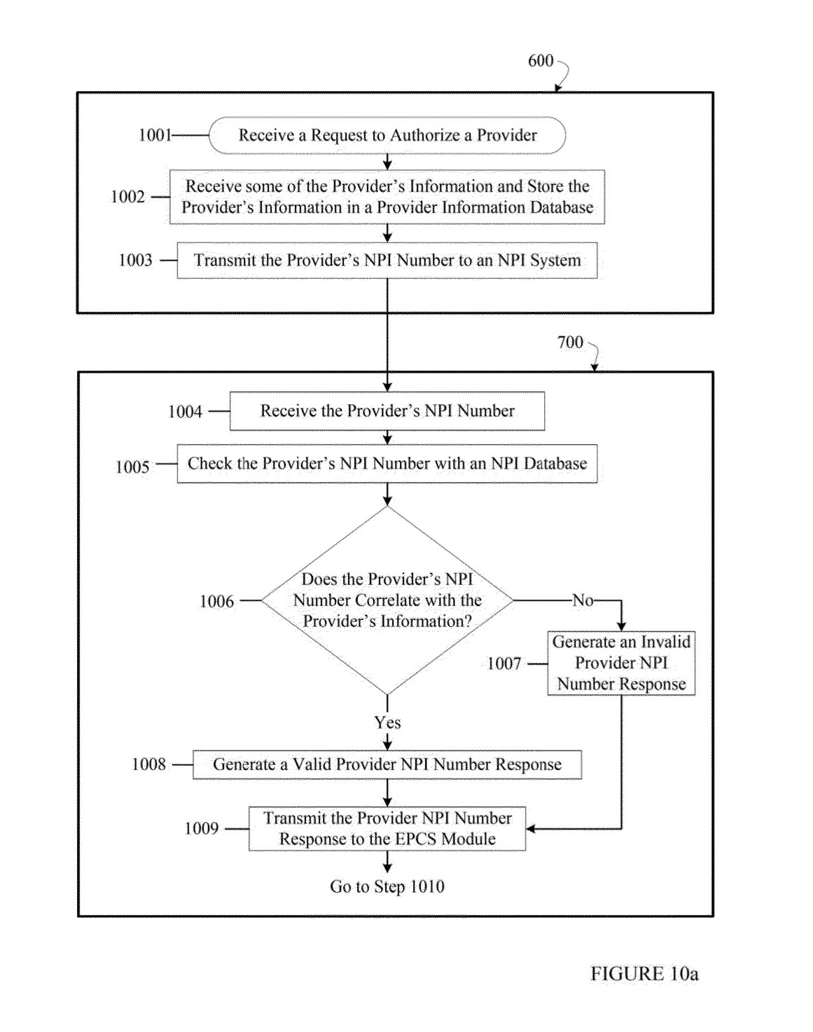

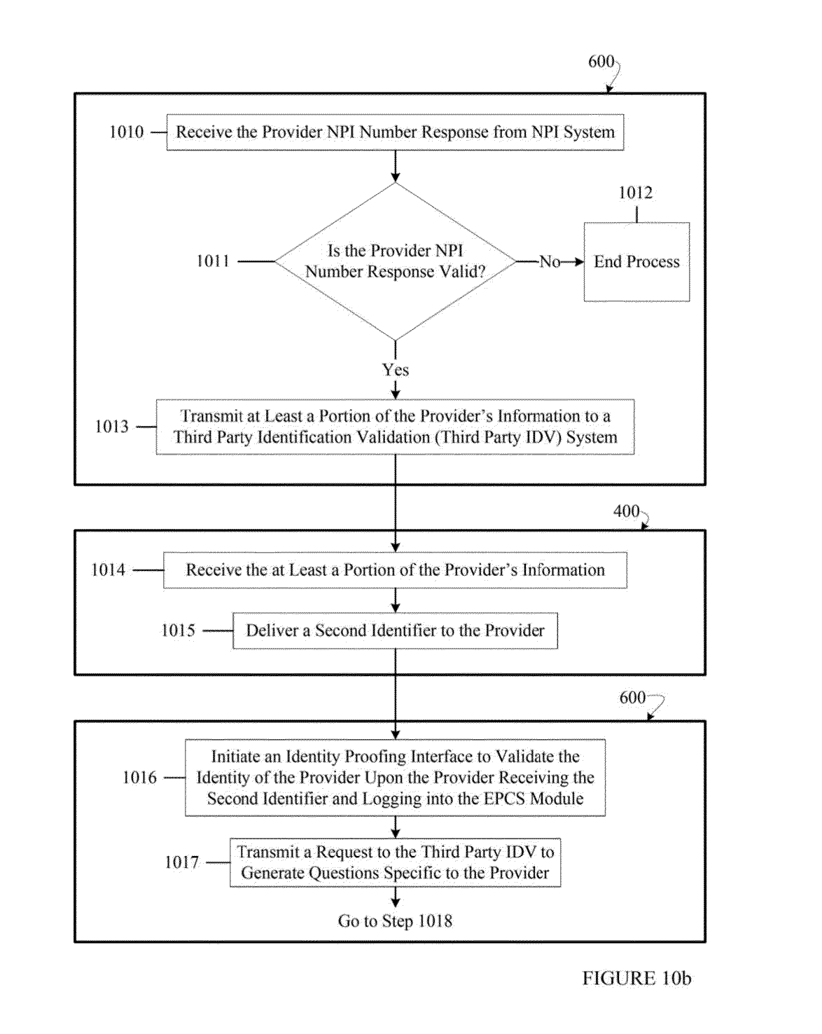

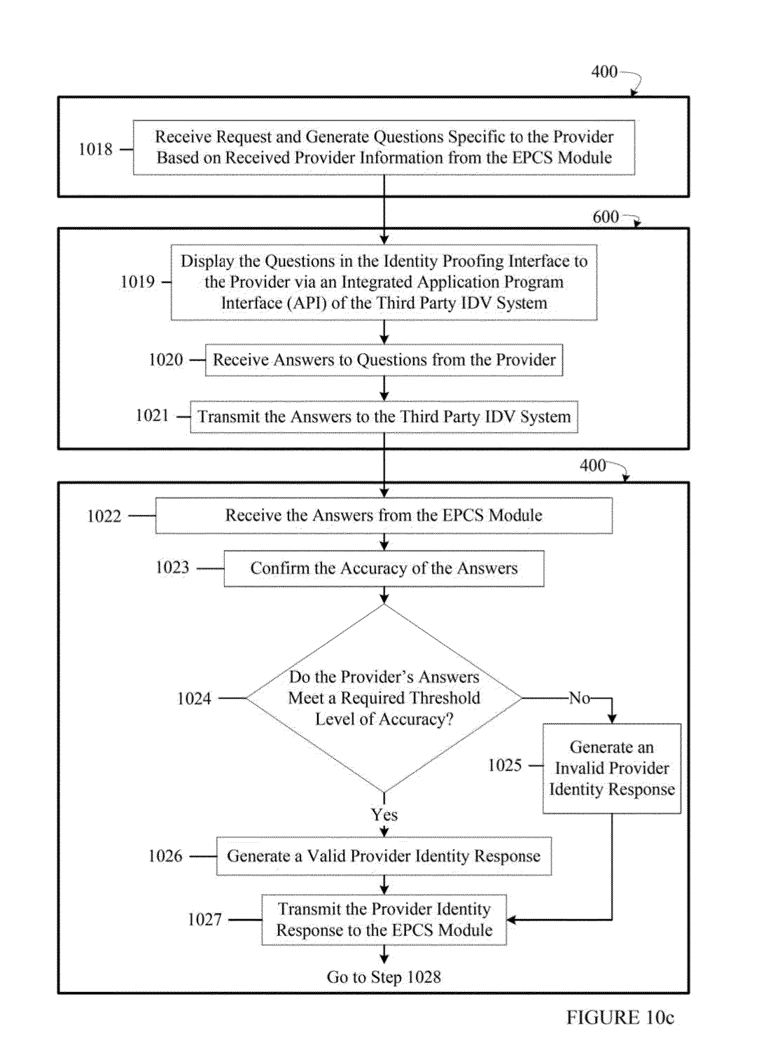

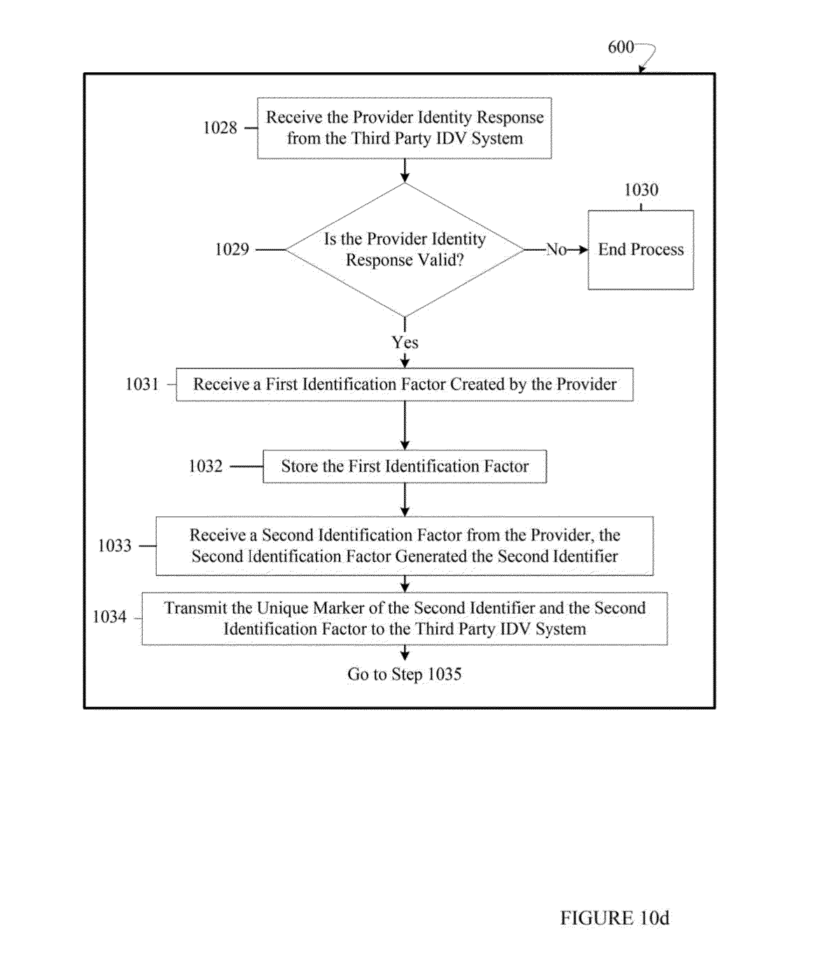

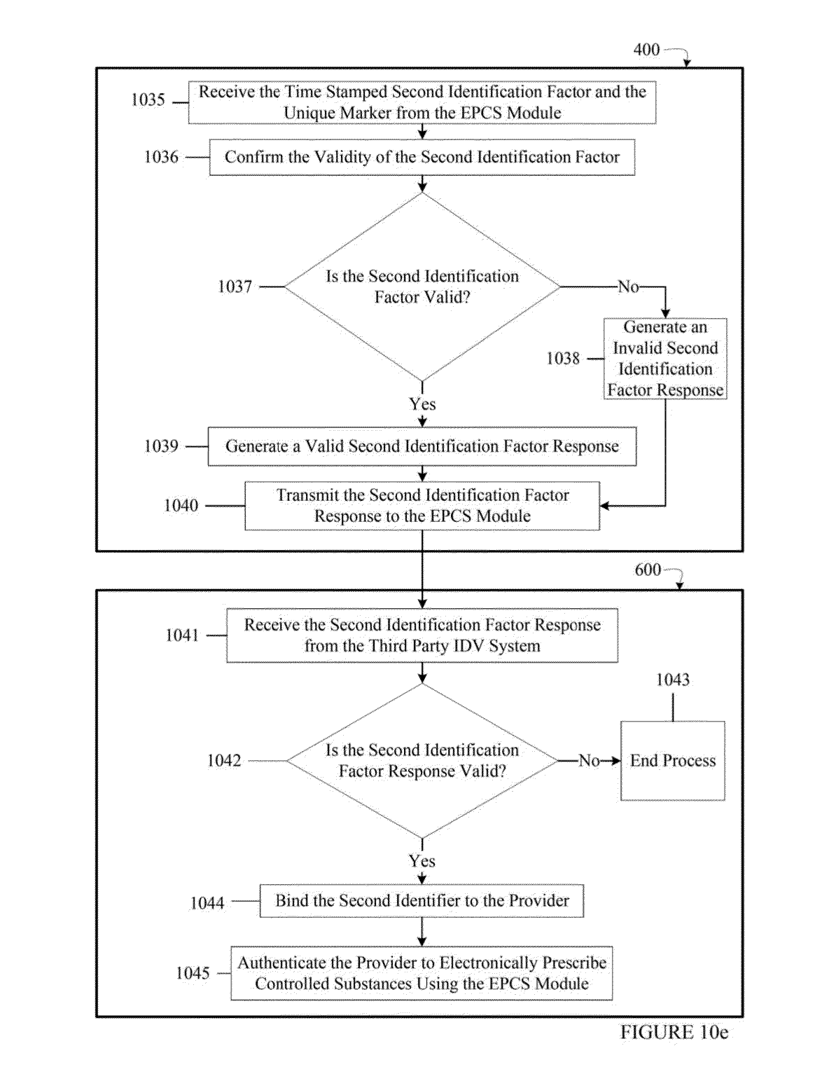

Referring to FIGS. 10a-10e, one embodiment of authorizing a provider 201 according to the present invention is schematically illustrated. As will be discussed in more detail below, steps 1000-1003, 1010-1013, 1016-1017, 1019-1021, 1028-1034 and 1041-1045 are performed by the EPCS module 600. Steps 1004-1009 are performed by the NPI system 700. Steps 1014-1015, 1018, 1022-1027 and 1035-1040 are performed by the third party IDV system 400. Further, it should be noted that any transmission and receipt of information/data between systems may be either direct or indirect.

FIGS. 10a-10e are discussed below with reference to the system of FIG. 1. As mentioned above, in the system 100, the EPCS module 600 comprises a centralized portion 601 that resides on the EP system 300 and a client portion 602 that resides on the HCP system 200. Therefore, although the EPCS module 600 may be described herein as performing a particular process, if that particular process is performed by the centralized portion 601 of the EPCS module 600, it can be conceptually described as being performed by the EP system 300. Similarly, if a particular process is performed by the client portion 602 of the EPCS module 600, it can be conceptually described as being performed by the HCP system 200. Stated simply, when the EPCS module 600 (or a portion thereof) resides on either the EP system 300 or the HCP system 200, the actions performed by the EPCS module 600 (or a portion thereof) can be described herein as being performed by the system in which the EPCS module 600 (or a portion thereof) resides. It should be further noted that in other embodiments of the invention, the EPCS module 600 may reside on a stand alone system or on another portion of the system 100. Thus the process steps of FIGS. 10a-10e may be performed by different systems/portions of the system 100, 101, 102 in alternate embodiments.

The process of authorizing a provider 201 is the registration process by which a provider 201 is registered to use the EPCS module 600 to electronically prescribe controlled substances. The process of authorizing a provider 201 generally comprises 3 steps: (1) initial registration of the provider 201; (2) identification (ID) proofing of the provider 201; and (3) binding a second identifier to the provider 201. The ID proofing process is performed to certify that the individual who is attempting to gain access to the EPCS module 600 is actually the provider 201. In one embodiment, the identity of the provider 201 is validated by presenting a series of questions to the provider 201 relating to the identity of the provider 201. The questions are generated by the third party IDV system 400 and displayed in the display device 206 of the HCP system 200, as will be described in more detail below. After the provider's identity has been validated, the EPCS module 600 binds a second identifier to the provider 201. After associating the second identifier to the specific provider 201, the EPCS module 600 records the associating in the unique marker database 306. As discussed below, this enables the provider 201 to electronically prescribe controlled substances using the EPCS module 600.

1.1 Initial Registration of a Provider

Referring to FIG. 10a, in the first step of the authentication process 1001, the EPCS module 600 receives a request to authorize a provider 201 that is generated by the HCP system 200. The request to authorize the provider 201 can be initiated by the provider 201. The request can be generated internally by the EPCS module 600 or can be received by the EPCS module 600 after being generated externally. In one embodiment, step 1001 is completed when a provider 201 logs into the EPCS module 600 and requests authorization. Upon the EPCS module 600 receiving the authorization request, the provider 201 will be prompted to enter certain personal information (e.g., the provider's full name, mailing address, NPI number, DEA number) by display of an appropriate GUI (or an API or web service) on the display device 206 of the HCP system 200 and receives a username. The provider 201 inputs the relevant personal information into the GUI using the input device 207 and submits the same. It should be noted that the display of the GUI may be via a web interface (portal) or an application user interface.

In some instances, the provider 201 may be required to pay a fee in order to complete the first step of the authentication process. In certain embodiments, the EPCS module 600 will transmit an invitation to the provider 201 to be authorized to use the EPCS module 600. The invitation can be in the form of an email containing a link that enables the provider 201 to access the EPCS module 600 and begin the authorization process.

Upon completion of step 1002, the EPCS module 600 stores the inputted personal information of the provider in the provider information database 303 of the memory 302 of the EP system 300. The EPCS module 600, through use of the processor of the system in which in resides, stores the personal information of the provider 201 in the provider information database 303 in a manner in which each provider 201 is correlated to their specific information. In alternate embodiments, the provider's information may be stored in any database on the system 100. This may occur in embodiments where the EPCS module 600 resides entirely on its own system.

In step 1003, the EPCS module 600 transmits the provider's NPI number (which was provided as part of the provider's personal information) to the NPI system 700 for validation. The NPI system 700 receives the provider's NPI number thereby completing step 1004. The NPI system 700 (through use of its processor 710) cross-references the provider's NPI number with data stored in the NPI database 701, completing step 1005. The NPI database 701 comprises a listing of providers 201 and their associated NPI numbers. Through cross-referencing with data stored in the NPI database 701, the NPI system 700 determines whether the received provider's NPI number correlates with the information stored in the NPI database, completing decision step 1006. If the provider's NPI number is determined to not correlate with the information stored in the NPI database 701, an “Invalid Provider NPI Number” response is generated by the NPI system 700 at step 1007, which is then transmitted to the EPCS module 600 at step 1009. To the contrary, if the provider's NPI number is confirmed to correlate with the information stored in the NPI database 701, a “Valid Provider NPI Number” response is generated at step 1008, which is then transmitted to the EPCS module 600 at step 1009. In summary, at step 1009, the NPI system 700 transmits the appropriate provider NPI number response (either “Valid” or “Invalid”) to the EPCS module 600 for further processing.

Referring now to FIG. 10b, the EPCS module 600 receives the provider NPI number response that is generated by the NPI system 700, completing step 1010. The EPCS module 600 then checks to determine whether the received response is “Valid” or “Invalid” thereby completing decision step 1011. If the response is “Invalid,” then the process stops and the provider 201 is not authorized by the EPCS module 600, completing step 1012. If the response is “Valid,” then the EPCS module 600 updates an NPI file that is stored within the memory of the EP system 300. The NPI file comprises a correlated list of providers 201 and their NPI numbers. The EPCS module 600 then transmits at least a portion of the provider's information to a third party IDV system 400, completing step 1013. As noted above, a third party IDV system 400 is a system (or combination of systems/sub-systems) that is capable of validating the identity of an individual, such as the provider 201, in accordance with DEA guidelines.

It should be noted that the invention is not so limited. In one alternate embodiment, the EPCS module 600 does not transmit the provider's NPI number to an NPI system 700. Rather, the EP system 300 comprises an internally stored NPI database that is periodically updated via the NPI system 700. In one such embodiment, the EPCS module 600 confirms the NPI number inputted by the provider 201 by cross-referencing it to the NPI database of the EP system 300. As a result, the EPCS module 600 does not have to reach out to NPI system 700 to confirm a provider's NPI number because the NPI database of the EP system 300 will be up to date due to being periodically updated. Thus, in such an embodiment, steps 1003-1010 are omitted from the authorization process and the EPCS module 600 confirms the provider's NPI number with an NPI database stored in the memory of the EP system 300. In such instances, the EP system 300 will generate and transmit the appropriate “Valid” or “Invalid” signal to the EPCS module 600, and then continue to step 1013.

Returning now to FIG. 10b, after the EPCS module 600 has confirmed the validity of the provider's NPI number, the EPCS module 600 transmits at least a portion of the provider's information to the third party IDV system 400, completing step 1013. According to one embodiment, the EPCS module 600 transmits the provider's name and mailing address to the token delivery sub-system 401 of the third party IDV system 400, along with a request to deliver a second identifier to the provider 201. It should be noted that the provider's information is not limited to their name and mailing address, and may include any of the provider's information received by the EPCS module 600. Further, although exemplified as being performed after steps 1003-1011, the EPCS module 600 may transmit the provider's information to the third party IDV system 400 at any point after the EPCS module 600 has received the provider's information in alternate embodiments.

The third party IDV system 400, and specifically the token delivery sub-system 401, receives the provider's information (e.g., full name and mailing address) completing step 1014. The third party IDV system 400 then delivers a second identifier to the provider 201, completing step 1015. The delivery of the second identifier to the provider 201 may be an electronic transmission or a physical transmission. For example, by a courier service (e.g., the United States Postal Service), electronic mailing (e-mail) or a downloadable application. Further, in one embodiment of the present invention, a confirmation of delivery of the second identifier (e.g., a tracking number or email confirmation) can be generated by the third party IDV system 400 and transmitted to the EPCS module 600 for storage in the first identification factor database 304.

According to one embodiment of the present invention, the second identifier is a physical device. In the preferred embodiment, the second identifier is a hard token, or physical device that generates a one-time password each time it is activated. In an alternate embodiment, the second identifier may be an electronic password that is used to access a software application (soft token) that similarly generates a one-time password each time it is activated. It should be understood that in alternate embodiments the second identifier may be the software program itself. For example, upon receiving a request from the EP system 300, the third party IDV system may mail a hard token (physical device) to the provider's mailing address or may email a soft token (e.g., a software program or a password to access a software program) to the provider's email address.

The second identifier generates a second identification factor that is not known by the EPCS module 600, but is known (or can be calculated) by the third party IDV system 400. For example, a token (hard or soft) will generate a different one-time password each time it is activated by the provider 201 using an algorithm. In one embodiment, activation of the token may be accomplished by pressing a button. However, in another embodiment, activation of the second identifier may be opening an application or clicking a particular virtual button within the application. Each one-time password, which may be a series of numbers and/or letters, is one type of second identification factor.

It should be understood that the invention is not so limited, and in alternate embodiments the second identifier and second identification factor may be any apparatus used to authenticate the identity of the provider 201 through use of a third party IDV system 400. For example, the second identifier may be a device used to determine a biometric (physical or behavioral trait) of the provider 201 and the second identification factor may be the acquired biometric of the provider 201. For example, the second identifier may be a finger print scanner and the second identification factor the acquired finger print of the provider 201. Alternatively, the second identifier may be a software program (or a password for accessing a software program) for performing voice recognition or a retinal scan of the provider 201, while the second identification factor would be the acquired voice sample or the acquired retinal information received by the program. In such instances, the correlation of the second identification factor (acquired biometric) to the provider 201 is not known by (i.e., not stored in) the EPCS module 600 (or the EP system 300), but rather only known (or able to be calculated) by the third party IDV system 400.

Moreover, each second identifier has a unique marker associated therewith. The unique marker may be a serial number, a product key or any other marker that is unique to that specific second identifier.

Furthermore, it should be noted that in some embodiments the provider 201 may already have been issued a second identifier by the third party IDV system 400 (for reasons related to or unrelated electronic prescribing). In such situations, the third party IDV system 400 does not have to deliver a second identifier to the provider 201 in response to the EPCS module 600, and steps 1014-1015 may be omitted.

1.2 ID Proofing

After the third party IDV system 400 delivers the second identifier to the provider 201, the provider 201 receives the second identifier. Upon receipt of the second identifier, the provider 201 logs into the EPCS module 600. The EPCS module 600 then generates an identity proofing GUI that is displayed in the display device 206 of the HCP system 200, completing step 1016. As discussed in more detail below, the identity proofing GUI is used to validate the provider's identity to confirm that they are who they claim to be.

In one embodiment, after the EPCS module 600 receives confirmation that the second identifier has been delivered to the provider 201, the EPCS module 600 generates and transmits an invitation identification number to the provider 201. The invitation identification number (along with the provider's NPI number) allows the provider 201 to log into the EPCS module 600 to begin the identity proofing process. During the identity proofing process, the EPCS module 600 validates the provider's identity through interaction with and use of the third party IDV system 400. After the provider 201 logs into the EPCS module 600 using their invitation identification number and NPI number (using the GUI shown in FIG. 13a), the provider 201 is asked to agree to the terms of use of the EPCS module 600 (using the GUI shown in FIG. 13b). The provider 201 then inputs their information into the GUI, as shown in FIG. 13c. In certain embodiments, the EPCS module 600 can auto-populate certain fields by retrieving information from the NPI database 701 during the EPCS module's initial confirmation of the provider's NPI number. Any missing information is then entered by the provider 201 (as shown in the GUI of FIG. 13c).

Thereafter, the EPCS module 600 transmits at least a portion of the provider's information (e.g., name, address, social security number, credit card information, etc.) and an ID proofing request to the ID proofing sub-system 402, thereby completing step 1017. Upon receipt of the ID proofing request, the ID proofing sub-system 402 generates questions specific to the provider, completing step 1018. In order to generate the provider specific questions, the ID proofing sub-system 402 verifies the credit information of the provider 201 and uses information gained from the provider's credit report to generate the list of provider specific questions. Therefore, in one embodiment, the generated questions are based on a credit check of the provider 201. However, the invention is not so limited, and in alternate embodiments the questions may be generated using any other information relating to the provider's identity.

After the ID proofing sub-system 402 generates the questions, the questions are presented to the provider 201 via an integrated API of the third party IDV system 400 (third party API) that is generated by the EPCS module 600. Specifically, the third party API is displayed in the display device 206 of the HCP system 200 as the GUI of FIG. 13d, thereby completing step 1019. The third party API is generated by the third party IDV API sub-module 605 of the EPCS module 600 and populated by the third party IDV system 400. The EPCS module 600, via the third party API, displays the questions to the provider 201 on the display device 206 so that the provider 201 does not have to be redirected to a third party IDV site. Rather, the provider 201 can simply answer the questions during the identity proofing process while logged into the EPCS module 600. Thus, the provider 201 may view and respond to the questions generated by the third party IDV system 400 via the third party API generated by the EPCS module 600.

Once the questions are displayed on the display device 206, the provider 201 inputs responses to the questions using the input device 207, completing step 1020. Upon being submitted, the EPCS module 600 transmits (or routes) the answers, via the third party API, to the ID proofing sub-system 402, completing step 1021. In the exemplified embodiment, steps 1020 and 1021 are performed via the integrated API of the third party IDV system 400, which allows the ID proofing sub-system 402 to present questions to the provider 201 on the display device 206 of the HCP system 200 through a single point of interface, namely the EPCS module 600. Since the third party API is created by and resides on the EPCS module 600, the communication between the third party IDV system 400 and the provider 201 is handled by the EPCS module 600, thereby allowing the provider 201 to interact with the third party IDV system 400 without having to log into another system. In this sense, the EPCS module 600 acts as a gateway or portal.

After the answers to the questions are received by the ID proofing sub-system 402, which completes step 1022, the ID proofing sub-system 402 confirms the accuracy of the answers by cross-referencing the inputted answers to the data retrieved from the provider credit information database 406. Thus, validation of the identity of the provider 201 can be accomplished, completing step 1023. Specifically, the ID proofing sub-system 402 determines (through its cross-referencing) whether the provider's answers meet a required threshold level of accuracy, completing step 1024. The required threshold level of accuracy may be any minimum level determined by the EPCS module 600 (or established by the ID proofing sub-system 402). For example, it may be required that all of the questions be answered correctly or, alternatively, that only 80% of the questions be answered correctly. Further, in one embodiment of the present invention, the ID proofing sub-system 402 may provide questions that are intentionally false.

If the provider's answers meet the required minimum threshold of accuracy, the ID proofing sub-system 402 generates a “Valid” provider identity response, completing step 1026. Conversely, if the provider's answers fail to meet the required minimum threshold of accuracy, then the ID proofing sub-system 402 generates an “Invalid” provider identity response, completing step 1025. In an alternate embodiment of the present invention, the provider 201 may be provided with more than one opportunity to answer a sufficient number of the generated questions correctly prior to the ID proofing sub-system 402 generating an “Invalid” response. After a response is generated, the ID proofing sub-system 402 transmits the provider identity response to the EPCS module 600, completing step 1027.

Further, in an alternate embodiment of the present invention, the EPCS module 600 may use a manual process for generating provider specific questions and authenticating the identity of the provider 201, in lieu of steps 1017-1026. For example, in one embodiment, after the EPCS module 600 transmits at least a portion of the provider's information and an ID proofing request to the identification authentication sub-system 401 of the third party IDV system 400, the EPCS module 600 can receive the provider specific questions. Thereafter, the EPCS module 600 can deliver hard copies of the provider specific questions to the provider 201 via a mailing service (e.g., the United States Postal Service) or electronically through email or text message. After the provider 201 inputs answers the questions, the provider 201 is required to have the answers notarized prior to delivering the answers back to the EPCS module 600 or the ID proofing sub-system 402 of the third party IDV system 400 for confirmation. Upon confirmation by the ID proofing sub-system 402, the EPCS module 600 validates the provider 201 and the process moves to step 1031.

After the provider 201 answers a sufficient number of the generated questions correctly and the ID proofing sub-system 402 transmits a provider identity response, the EPCS module 600 receives the provider identity response, completing step 1028. Next, the EPCS module 600 determines whether the provider identity response is “Valid”, completing step 1029. If the provider identity response is “Invalid,” then the process is ended at step 1030. However, if the provider identity response is “Valid,” then the provider's identity is successfully verified (shown in the GUI of FIG. 13e) and the provider 201 is then requested to create a first identification factor as shown in the GUI of FIG. 13f, completing step 1031.

1.3 Token Binding

The first identification factor is one of a plurality of factors used by the EPCS module 600 to authenticate the provider 201 when receiving an electronic prescription request for a controlled substance. In the exemplified embodiment, the first identification factor is something known to the EPCS module 600 (i.e., stored therein or accessible thereby) and the provider 201 and not to certain other systems or modules (e.g., the third party IDV system 400) of the system 100. For example, in one embodiment, the first identification factor is a password, sometimes referred to as a passphrase or PIN, which is a series of letters and/or numbers created by the provider 201. After the first identification factor is created by the provider 201 and inputted using the input device 207 of the HCP system 200, the EPCS module 600 stores the first identification factor within the first identification factor database 304 of the EP system 300, thereby completing step 1032. Upon being stored in the first identification factor database 304, the first identification factor is correlated with the specific provider 201. This association is also stored in the first identification factor database 304. However, the invention is not so limited, and in other embodiments the first identification factor can be saved in any other location on the system 100 other than the EP system 300. It should be noted, however, that the first identification factor and the second identification factor(s) (discussed in more detail below) are not stored in the same database or on the same system to prevent the acquisition of both the first and second identification factors by a hacker in a single security breach.

After the first identification factor is stored by the EPCS module 600, completing step 1032 and as shown in the GUI of FIG. 13g, the provider 201 registers their second identifier with the EPCS module 600, as shown in the GUI of FIG. 13h. As previously noted, the second identifier was previously received by the provider 201 via the token delivery sub-system 401. According to one embodiment, in order to register the second identifier with the EPCS module 600, the provider inputs the following registration information into the EPCS module via the input device 207 of the HCP system 200: (1) a name for their second identifier; (2) the unique marker of the second identifier (e.g., a serial number, a product key number, or other identifier of the second identifier); and (3) a second identification factor that is generated by the second identifier, thereby completing step 1033. As noted above, in the exemplified embodiment the second identification factor is generated by the second identifier when the second identifier is activated by the provider 201. For instance, the second identification factor may be a one-time password or an acquired biometric of the provider 201 generated by the second identifier.

After the EPCS module 600 receives the registration information of the provider's second identifier, the EPCS module 600 time stamps the second identification factor. The EPCS module 600 then transmits the second identification factor, the time stamp, and the unique marker of the second identifier to the token management sub-system 403 of the third party IDV system 400 for confirmation, completing step 1034. It should be noted that in certain embodiments, and depending on the type of second identifier used, the EPCS module 600 may not have to time stamp the second identification factor prior to transmitting it to the token management sub-system 403 (e.g., when the second identification factor is a biometric).

The token management sub-system 403 of the third party IDV system 400 receives the second identification factor, the time stamp, and the unique marker of the second identifier from the EPCS module 600, completing step 1035. In order to confirm the validity of the second identification factor provided y the EPCS module 600, the token management sub-system 403 analyzes the received unique marker and retrieves a time-dependent algorithm that is stored in the second identifier database 405, and which is associated with the received unique marker. The token management sub-system 403, through its processors, runs the retrieved time-dependent algorithm using the received time stamp as the variable input and obtains an algorithm output. The management sub-system 403 then compares the algorithm to the received second identification factor that was supplied by the EPCS module 600 to determine whether there is a match between the two. If there is a match, the validity of the received second identification factor is confirmed. Conversely, if there is not a match, the received second identification factor is deemed invalid. As a result, steps 1036 and 1037 are completed. In embodiments where the second identification factor is a biometric, the token management sub-system 403 only has to confirm that the received biometric correlates with the biometric of the provider 201 stored in the second identifier database 405.

If the second identification factor is determined to be invalid, then an “Invalid” second identification factor response is generated by the third party IDV system 400, completing step 1038. Conversely, if the second identification factor determined to be valid, then a “Valid” second identification factor response is generated by the third party IDV system 400, completing step 1039. After a second identification factor response is generated, the third party IDV system 400 transmits the second identification factor response to the EPCS module 600, completing step 1040.

Upon receiving the second identification factor response from the third party IDV system 400 in step 1041, the EPCS module 600 determines whether the second identification factor response is “Valid”, completing decision step 1042. If the second identification factor response is “Invalid,” then the process is ended at step 1043. However, if the second identification factor response is “Valid,” then the EPCS module 600 binds the provider 201 to their second identifier as shown in the GUI of FIG. 13i, thereby completing step 1044. In the exemplified embodiment, the binding of the second identifier to the provider 201 associates the second identifier with the provider 201 within the first identification factor database 304 of the EP system 300, and stores said association therein. Therefore, the provider 201 is authorized by the EPCS module 600 to electronically prescribe controlled substances, thereby completing step 1045.

As shown in FIG. 13i, according to one embodiment of the present invention, the second identifier (exemplified as a token), its unique marker (e.g., serial number) and a status (e.g., active/disabled) is saved in association with its provider 201 in the unique marker database 306 of the EP system 300. Nonetheless, it should be noted that the unique Marker database 206 is not limited to the amount or type of information stored therein. In the exemplified embodiment, the unique marker database 306 stores at least a correlated list of providers 201 and the unique marker(s) of their second identifier(s). As a result of the above, the provider 201 is authorized by the EPCS module 600 and bound to their second identifier. The provider 201 may then log off the EPCS module 600, as shown in the GUI of FIG. 13j.

Upon the provider 201 being bound to their second identifier, the authorization process is complete. However, in an alternate embodiment, the token may not be bound to the provider 201 and, thus, the authorization process is not complete until the EPCS module 600 requests that the token delivery sub-system 401 delivers to the provider 201 an identity proofing confirmation number and the provider 201 logs back into the EPCS module 600 to confirm the token binding process using the identity proofing confirmation number.

Further, in one embodiment, additional tokens may be bound to the provider 201, without requiring the provider 201 to have to go through the ID proofing process again, as long as the provider 201 has already been authorized by the EPCS module 600 and is already bound to at least one other token. Nonetheless, if the provider 201 loses all of their bound tokens, then the provider 201 is required to go through the ID proofing process again.

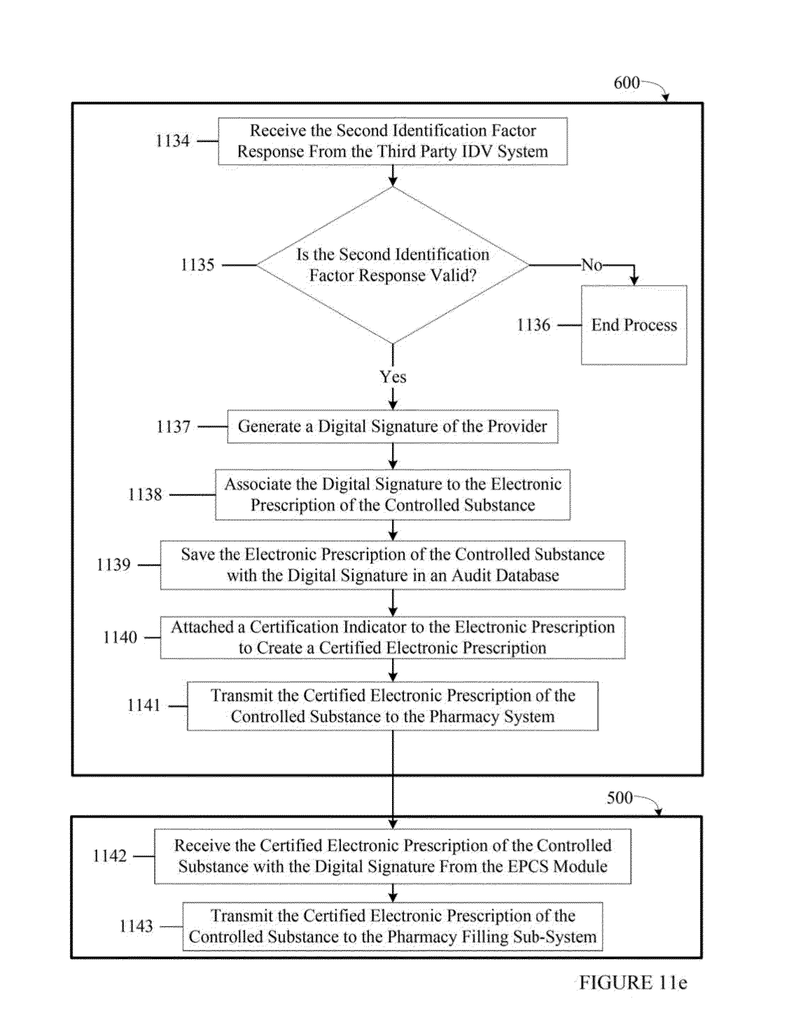

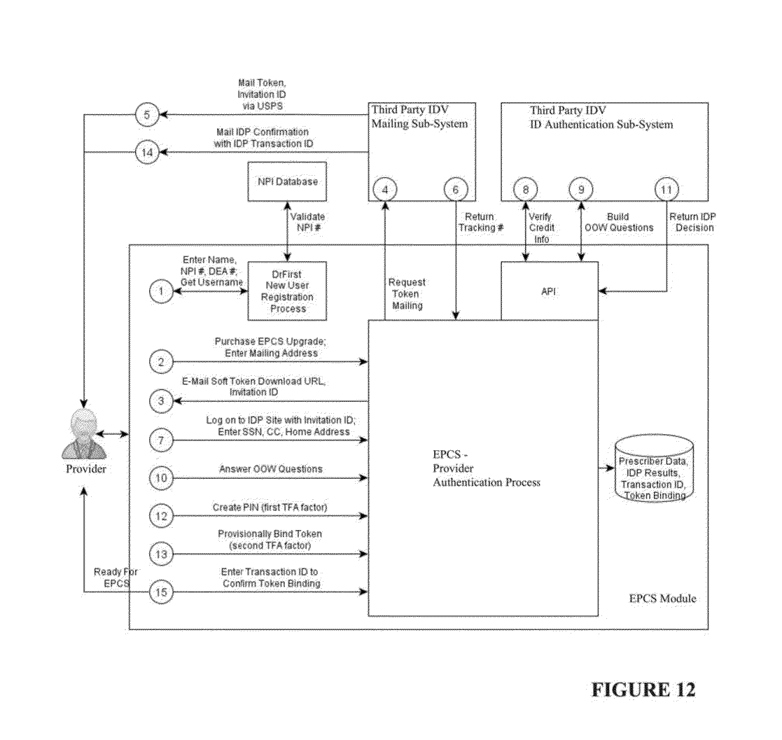

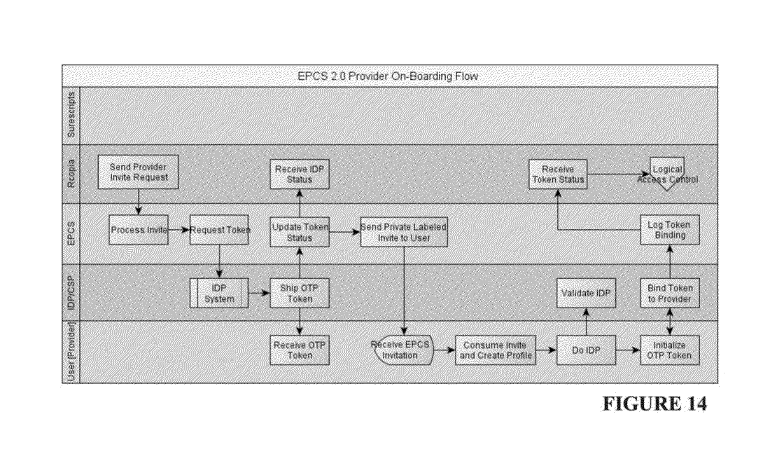

Referring to FIG. 12, an alternate embodiment of authorizing a provider 201 and binding a provider 201 to a second identifier (e.g., a token) is illustrated. Further, referring to FIG. 14, another alternate embodiment of authorizing a provider 201 and binding a provider 201 to a second identifier is illustrated. As exemplified in FIG. 14., it should be noted that “EPCS” stands for the EPCS module 600 of the present invention, “Rcopia®” stands for the EP module 205 of the present invention, “Surescripts®” stands for the pharmacy system 500 and “IDP/CSP” stands for the third party IDV system 400 of the present invention. Nonetheless, it should be clear that the present invention is not limited to the use of any specific EPCS module 600, EP module 205, pharmacy system 500 or third party IDV system 400.

2. Granting an Authorized Provider Access to the EPCS Module

After the provider 201 is authorized by the EPCS module 600, the provider 201 still must be granted access by the HCP system 200 to use the EPCS module 600. In the exemplified embodiment, the process of granting access to a provider 201 is accomplished via an Access Control Module (ACM) of the EPCS module 600. The ACM allows a staff administrator of the provider's HCP System 200 to control which providers 201 within their system have access to prescribe controlled substances. For example, the staff administrator may modify EPCS module 600 access privileges of the providers 201 of their specific HCP system 200. Therefore, even if a provider 201 is authorized by the EPCS module 600 to electronically prescribe controlled substances (as described above), the provider 201 must also be granted access by a local staff administrator of their HCP system 200 in order to be able to electronically prescribe a controlled substance via that specific HCP system 200. However, it should be noted that in an alternate embodiment of the present invention, the provider 201 does not have to be granted access by their HCP system 200 prior to electronically prescribing controlled substances.

Further, the ACM also allows for the control, such as editing and removing, of the accounts for each provider 201 as they relate to that specific HCP system 200. As noted above, an individual provider 201 may be granted access to the EPCS module 600 under multiple HCP systems 200. Therefore, the grant or revocation of access to electronically prescribe from one HCP system 200 does not necessarily preclude the provider 201 from electronically prescribing controlled substances via the EPCS module 600 altogether. Further, it should be noted that in one alternate embodiment of the present invention, the provider 201 is granted access upon completion of the authorization process, and therefore, does not have to go through a separate access granting process via the ACM of the EPCS module 600. In alternate embodiments, the process of granting the provider 201 access via the ACM may be omitted.

The process of granting a provider 201 access to use the EPCS module 600 via a specific HCP system 200 is discussed below with reference to FIG. 1. Specifically, the process is discussed with reference to a system 100 in which the EPCS module 600 comprises a centralized portion 601 that resides on the EP system 300 and a client portion 602 that resides on the HCP system 200.

As noted above, in accordance with one embodiment of the present invention, in order for a provider 201 to be able to sign and send electronic prescriptions for controlled substances via a particular HCP system 200, the provider 201 must first be granted access by a staff administrator of their HCP system 200. In one embodiment, access is granted by two individuals: (1) a member of HCP system 200 that is granted with “administrator” status (a staff administrator); and (2) an authorized provider 201 who has previously completed the multi-factor authentication process with the EPCS module 600. According to one embodiment, the authorized provider 201 has been authenticated by the EPCS module 600 and granted access for a specific HCP system 200 and, therefore can electronically prescribe controlled substances via the EPCS module 600.

The invention, however, is not so limited and in one embodiment, the authorized provider 201 may be the provider 201 who is attempting to have their access granted for their HCP system 200. Therefore, the provider 201 only needs a staff administrator to confirm their identity and be granted access to the EPCS module 600 for their specific HCP system 200. Further, in another embodiment, the provider 201 may use an administrator of the EPCS module 600 in order to grant themselves access to use the EPCE module 600. This may be required in solo practices where there is no staff administrator and, therefore no one to confirm the identity of the provider 201 outside of the provider 201 himself/herself.

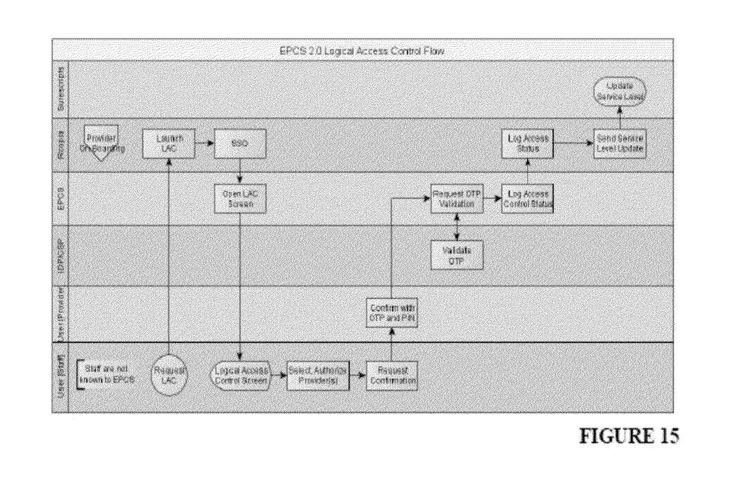

Referring now to FIG. 15, a method of granting access to a provider 201 according to one embodiment of the present invention is illustrated. First, the HCP system 200, as the result of a staff administrator's input, generates and transmits a request to the EPCS module 600 for a provider 201 to be granted access. As exemplified in FIG. 15, “EPCS” stands for the EPCS module 600, “Rcopia®” stands for the EP module 205, “Surescripts®” stands for the pharmacy system 500, and “IDP/CSP” stands for the third party IDV system 400. Nonetheless, it should be clear that the present invention is not limited to the use of any specific EPCS module 600, EP module 205, pharmacy system 500 or third party IDV system 400.

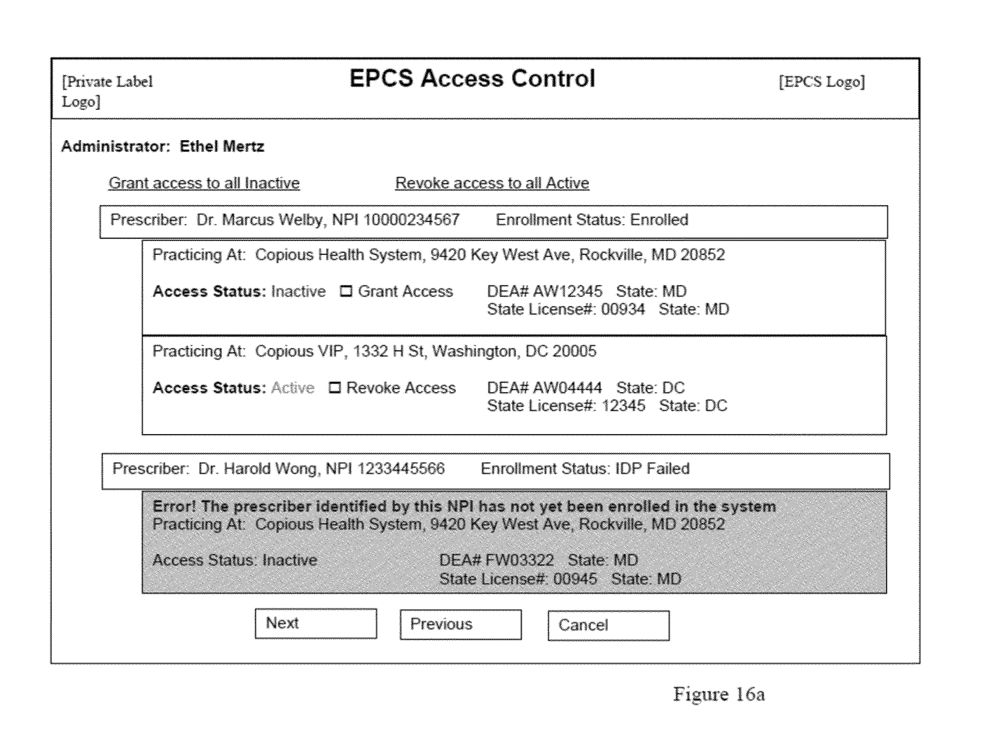

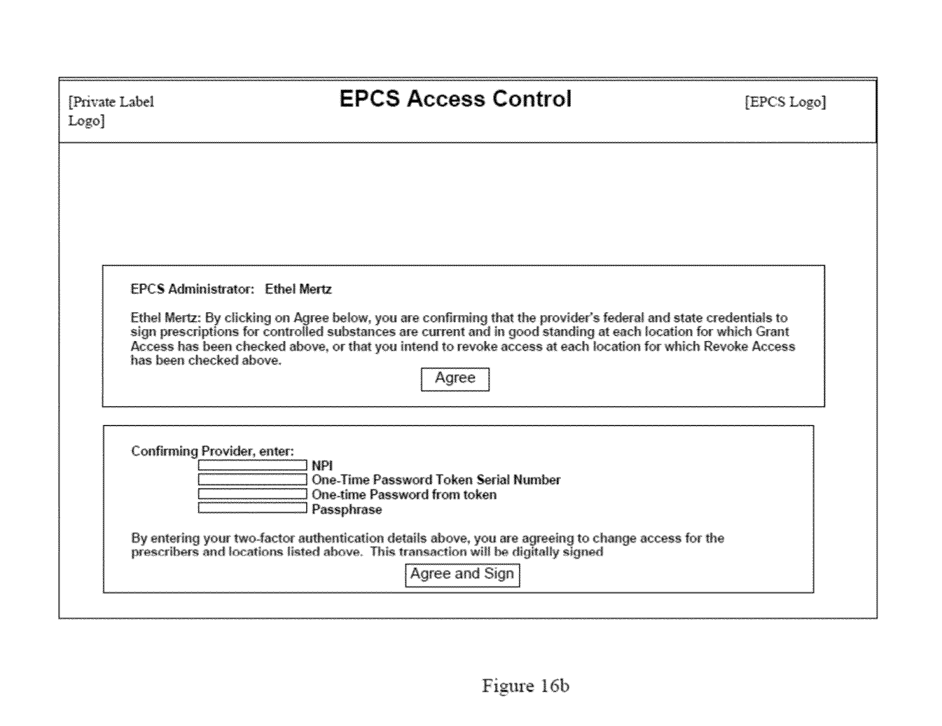

The EPCS module 600 receives the request from the HCP system 200 that a provider 201 would like to be granted access. In response to this access request, the EPCS module 600, via the ACM 604, begins the ACM process. The EPCS module 600 then generates and displays in the display device 206 of the HCP system 200, a GUI through which the staff administrator can select an authorized provider 201. The staff administrator then selects the authenticated provider 201 for which they would like to grant access. After the staff administrator selects a provider 201, the staff administrator is required to verify and attest that the provider's DEA registration number and state license to prescribe controlled substances are currently in good standing, as shown in the GUI of FIG. 161). After the staff administrator verifies the provider's credentials, the authenticated provider 201, which may be the provider 201 who is currently requesting access to be granted, must confirm the grant of access by completing their multi-factor authentication process, as shown in the GUI of FIG. 16b. As noted above, according to one embodiment, the multi-factor authentication process is a two factor authentication process comprising a first identification factor (e.g., a passphrase) and a second identification factor (e.g., a one-time password). However, as discussed above, it should be noted that the invention is not so limited.

The authenticated provider 201 is required to enter their first and second identification factors, the NPI number, and information relating to their second identifier (e.g., a name of their second identifier that is saved by the EPCS module 600 and/or the unique marker of the second identifier). This should be done during the same secure session as the staff administrator's verification of the provider's credentials. Thereafter, the entered information is transmitted from the HCP system 200 to the EPCS module 600 (in embodiments where the EPCS module comprises a client portion 602 and a centralized portion 601, the information is transmitted to the centralized portion 601 of the EPCS module 600).

Upon the EPCS module 600 receiving the authorized provider's entered information, the EPCS module 600 time stamps the second identification factor and validates the first identification factor using the first identification factor database 304 of the EP module 300. To validate the first identification factor, the EP module 300 determines whether the first identification factor correlates with the first identification factor of the provider that is previously stored in the first identification factor database 304.

Upon confirmation of the first identification factor, the EPCS module 600 transmits the second identification factor, the time stamp, and the unique marker of the authenticated provider's second identifier to the third party IDV system 400, and requests the third party IDV system 400 to validate the time stamped second identification factor. As previously noted, the EPCS module 600 does not know whether the second identification factor is valid and, therefore cannot validate the second identification factor. Rather, the EPCS module 600 transmits the time stamped second identification factor to the third party IDV system 400 for validation. After the third party IDV system 400 validates the second identification factor, an appropriate response is generated and transmitted back to the EPCS module 600 by the third party IDV system 400.

Upon the EPCS module 600: (1) receiving attestation from the staff administrator that the provider's DEA registration number and state license to prescribe controlled substances are currently in good standing; (2) validating the first identification factor with the first identification factor database 304; and (3) receiving confirmation from the third party IDV system 400 that the second identification factor is valid, the EPCS module 600 grants access to the provider 201 to electronically prescribe controlled substances via that particular HCP system 200.

It should be noted that in one embodiment of the present invention, an authorized provider 201 must be granted access for each HCP system 200 to which they belong. The provider 201 is only required to be authorized by the EPCS module 600 once, but may be required to be granted access by the ACM oldie EPCS module 600 for each HCP system 200 to which they belong. For example, if a provider 201 works at a hospital and has their own practice, the provider 201 may be required to be granted access from both the hospital HCP system 200 and their own practice HCP system 200 in order to be able to electronically prescribed controlled substances at each location using the EPCS module 600. Moreover, according to one embodiment of the present invention, each HCP system 200 that a provider 201 is associated with should have a physical address and/or IP address that is distinct from all other HCP systems 200.

Additionally, it should be noted that although a provider 201 may be associated with more than one HCP system 200, the provider 201 only has to go through the authorization process of the EPCS module 600 once and therefore only has to be issued one second identifier by the third party IDV system 400.

The ACM of the EPCS module 600 may also be used to revoke the access of a provider 201 for a particular HCP system 200. Revocation of access may be required if the provider 201 has lost their second identifier (in the case of a physical object such as a hard token), if the provider 201 is no longer in good standing with the DEA, the provider's DEA license expires without renewal, or lithe provider 201 is terminated, suspended, or otherwise leaves a particular HCP system 200. Access only needs to be revoked for each location at which the provider 201 is no longer authorized to prescribe controlled substances. Revocation of a provider's access should be digitally signed and stored in the audit database 307. The process of digitally signing an act may be done by the EPCS module 600 as discussed in more detail below.

Similarly, a provider 201 is also able to revoke their own access for a specific HCP system 200 or for all of their associated HCP systems 200. According to one embodiment, the provider 201 may require a second provider 201 and/or staff administrator in order to revoke their access. Further, when the provider 201 revokes their own access, the act should be digitally signed and stored by the EPCS module 600.

As shown in FIG. 16a, the ACM of the EPCS module 600 generates and presents to (e.g., via the display device 206 of the HCP system 200) the staff administrator a list of all providers 201 that are associated with the HCP system 200. Along with each provider's name, the ACM also generates and presents the location(s) where the provider 201 practices, their associated DEA number, the State of the DEA number, the State license number and the associated state. Further, the ACM presents the “Access Status” of each provider 201, along with an option to alter/change the access status. Additionally, if the provider 201 has not been granted access to the HCP system 200, a message indicating such will be presented to the staff administrator. In the exemplified embodiment, all of this information is stored in the memory 302 of the EP system 300. However, as previously noted, the invention is not so limited and in alternate embodiments the information may be stored elsewhere on the system 100. Further, if the supplied NPI number does not associate with an authorized provider 201 in the EPCS module 600, then an error message will be shown accordingly.

If a staff administrator would like to alter the access status of a provider 201 (from “Active” to “Inactive” or vise versa), a provider 201 who has been already authorized by the EPCS module 600 is required by perform the multi-factor authentication process as described above. For instance, in the preferred embodiment, an authorized provider 201 (which could be the provider 201 who is having their status altered) enters their NPI number, first identification factor, second identifier and second identification factor in order to confirm the change in the ACM of the EPCS module 600.

In the exemplified embodiment of the present invention, all actions (e.g., control/access requests, outcomes and status changes) performed via the ACM of the EPCS module 600 are stored in the audit database 305 for auditing purposes. As previously noted, in alternate embodiments the audit database 305 may reside anywhere on the system 100. Moreover, in alternate embodiments, the actions may not need to be stored if audit requirements are not mandated.

It should be noted that in the exemplified embodiment of the present invention, the provider 201 may only be granted access to electronically prescribe controlled substances after they have successfully been authorized by the EPCS module 600 (which includes the use of the third party IDV system 400), as described in detail above.

In the exemplified embodiment, the EPCS module 600 handles the gathering of provider 201 demographics, state license details and DEA license numbers. However, in alternate embodiments, other systems, such as the HCP system 200 may handle the gathering of provider 201 demographics, state license details and DEA license numbers and transfer the information to the EPCS module 600 and/or third party IDV system 400 for additional processing.

Further, according to one embodiment, if a provider 201 has more than one DEA number, then the provider 201 may be granted access via the ACM for each DEA number at any specific HCP system 200.

3. Processing an Electronic Prescription for a Controlled Substance

As noted above, according to one embodiment of the present invention, the method for prescribing controlled substances generally comprises three steps: (1) authorizing a provider 201; (2) granting an authorized provider 201 access to the EPCS module 600; and (3) processing an electronic prescription request for a controlled substance by an authorized provider 201. After a provider 201 has been authorized by the EPCS module 600 and has been granted access to the EPCS module 600 by a staff administrator of their HCP system 200, the provider 201 may begin electronically prescribing controlled substances using the EPCS module 600.

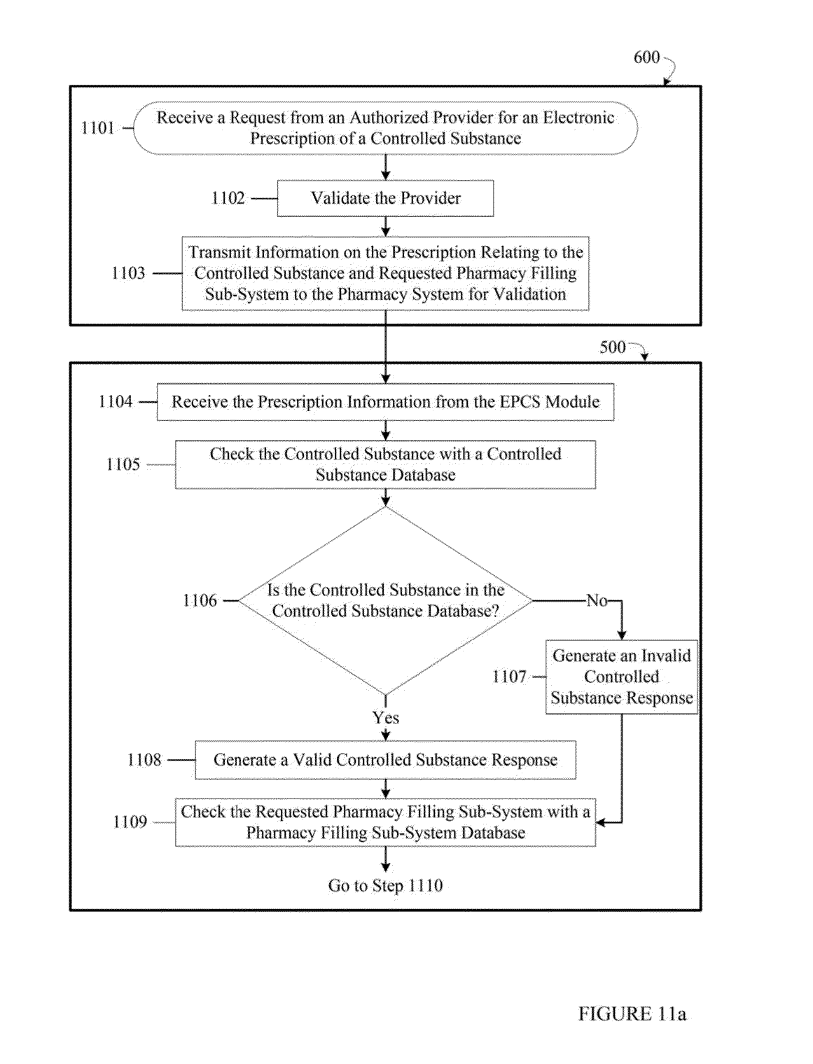

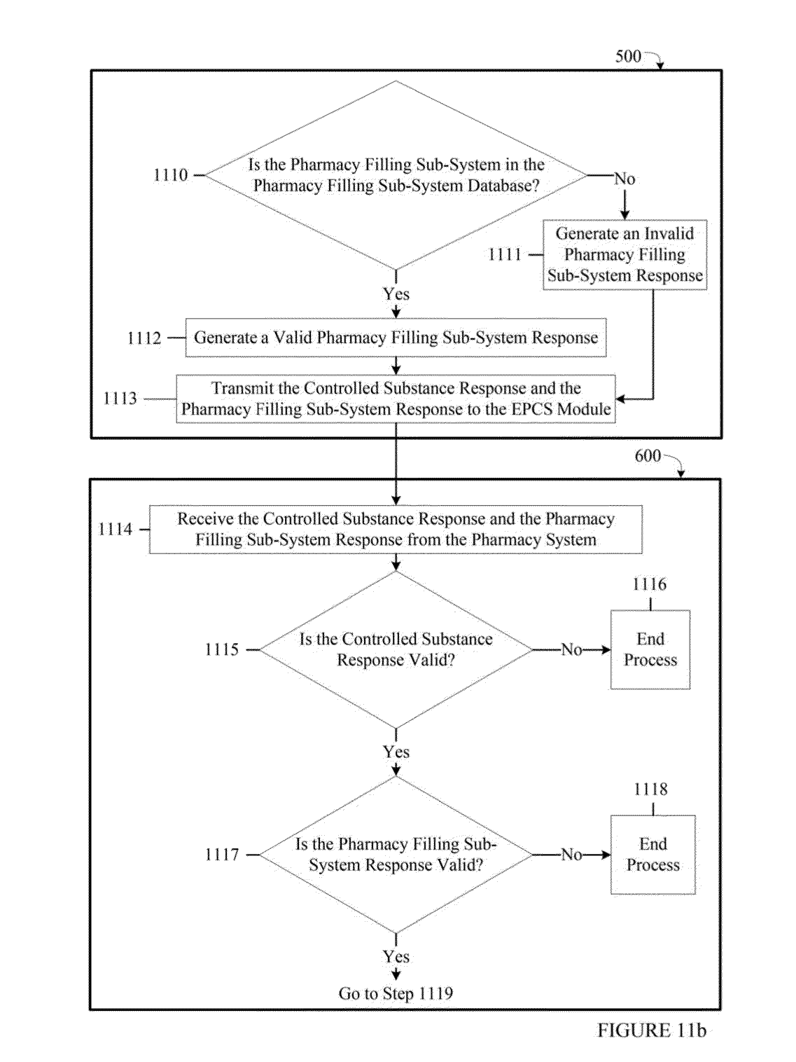

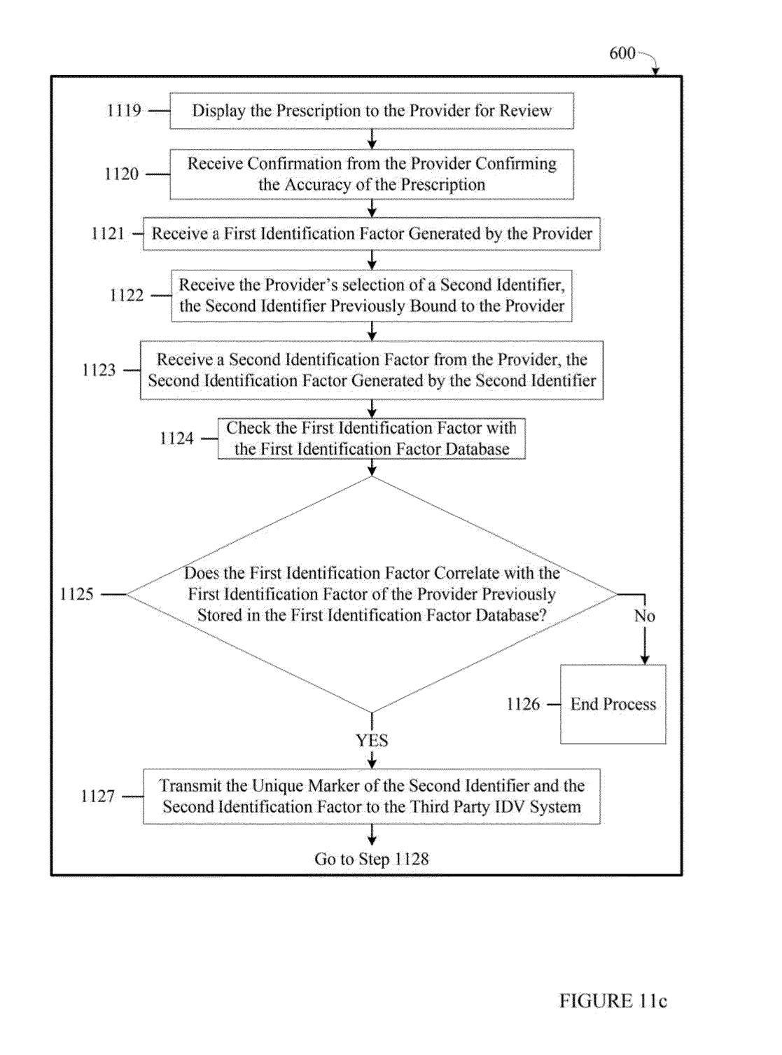

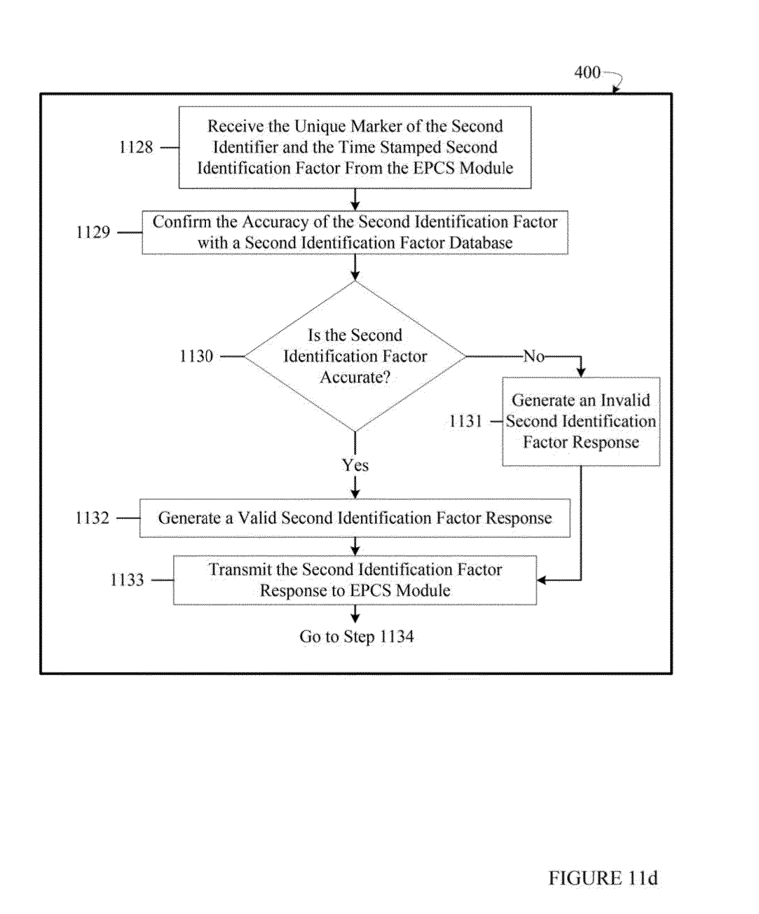

Referring to FIGS. 11a-11e, one embodiment of processing an electronic prescription for a controlled substance is illustrated. As will be discussed in more detail below, steps 1100-1103, 1114-1127 and 1134-1141 are performed by the EPCS module 600. Steps 1104-1113 and 1142-1143 are performed by the pharmacy system 500. Steps 1128-1133 are performed by the third party IDV system 400. Further, it should be noted that any transmission or receipt of data between systems or modules may be either direct or indirect.

FIGS. 11a-11e are discussed below with reference to the system 100 of FIG. 1. As mentioned above, in the system 100, the EPCS module 600 comprises a centralized portion 601 that resides on the EP system 300 and a client portion 602 that resides on the HCP system 200. Therefore, although the EPCS module 600 may be described herein as performing a particular process, if that particular process is performed by the centralized portion 601 it can be conceptually described as being performed by the EP system 300. Similarly, if a particular process is performed by the client portion 602 of the EPCS module 600, it can be conceptually described as being performed by the HCP system 200. Stated simply, when the EPCS module 600 (or a portion thereof) resides on either the EP system 300 or the HCP system 200, the actions performed by the EPCS module 600 (or the portion thereof) can be described herein as being performed by the system in which the EPCS module 600 (or the portion thereof) resides. It should be further noted that in other embodiments of the invention, the EPCS module 600 may reside on a stand alone system or on another portion of the system 100. Thus the process steps of FIGS. 10a-10e may be performed by different systems/portions of the system 100, 101, 102 in alternate embodiments.

According to one embodiment of the present invention, the HCP system 200 comprises an EP module 205, which may be an electronic prescription writing module used by a provider 201 to generate a particular electronic prescription. After a prescription request has been generated by the EP module 205, the EPCS module 600 will take over the subsequent processing steps of the electronic prescription request if it is determined that the substance to be prescribed is a controlled substance. As discussed below, the EPCS module 600 of the present invention allows for both synchronous and asynchronous methods of processing electronic prescriptions for controlled substances.

In the synchronous model, a single continuous user interface (which can include multiple sequential GUIs) is displayed and interfaced with by the provider 201 for both generating an electronic prescription for a controlled substance using the EP module 205 and certifying the electronic prescription using the EPCS module 600. Therefore, the synchronous model may be used when the EP module 205 and the EPCS module 600 utilize the same UI. When using the synchronous model, the provider 201 may fill out the prescription using the EP module 205, send the prescription to the EPCS module 600 for processing and then wait for a response from the EPCS module 600. Thereafter, the signing process, described in more detail below, is initiated by the EPCS module 600 in the same UI to certify the electronic prescription for processing by the pharmacy system 500. It should be noted that the synchronous model (from prescription writing in the EP module 205 to transmission of the certified prescription by the EPCS module 600) can be done in a, single secure session.

In the asynchronous model, the EP module 205 and the EPCS module 600 will have different UIs (or different windows). In this manner, the EPCS module 600 may be configured for use with a plurality of different EP modules 205, regardless of their UIs. According to the asynchronous model, after the prescription is generated by the provider 201 using the EP module 205, the EPCS module 600 receives a request to process the electronic prescription for the controlled substance from the EP module 205. Upon receiving the request, the EPCS module 600 creates a weblink for the provider 201 to perform the signing process and transmits the link back to the HCP system 200. By activating the link, the relevant interfaces will be generated by the EPCS module 600 and displayed to the provider 201 so that to perform the signing process (described in detail below) can be performed for the electronic prescription of the controlled substance. After the signing process is complete, the EPCS module 600 transmits a certified electronic prescription to the pharmacy system 500. Because the asynchronous module goes back and forth between the EP module 205 and the EPCS module 600, the weblink may be used by the provider 201 right when they receive the weblink or at a later time (e.g., at the end of the day).

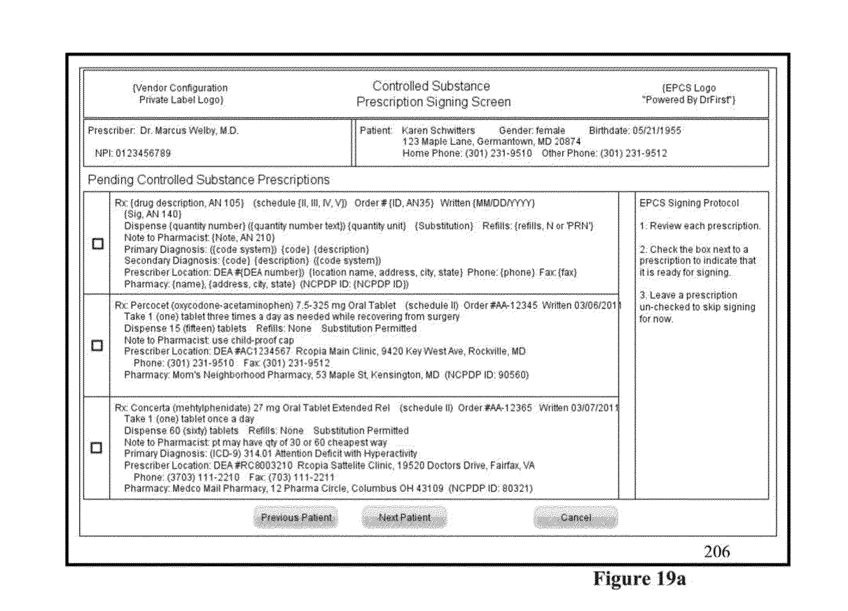

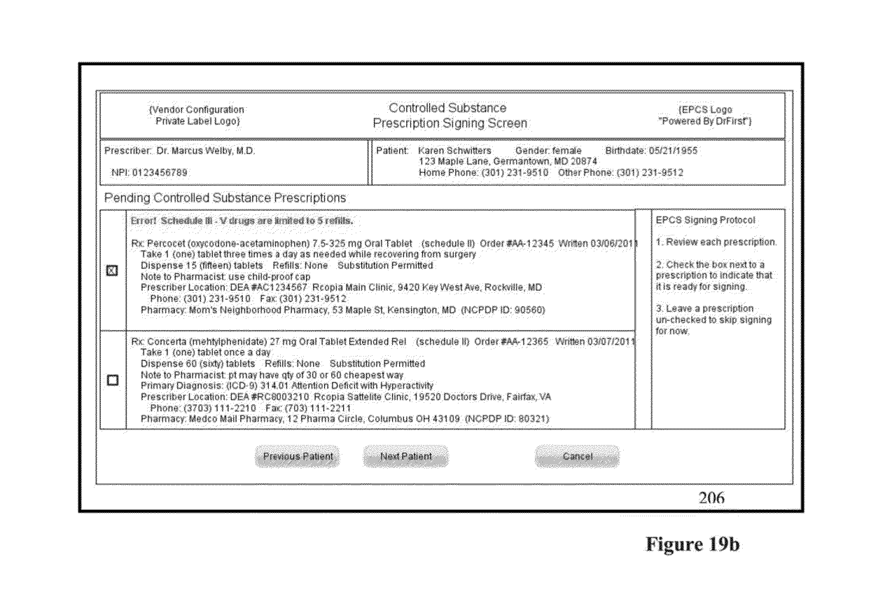

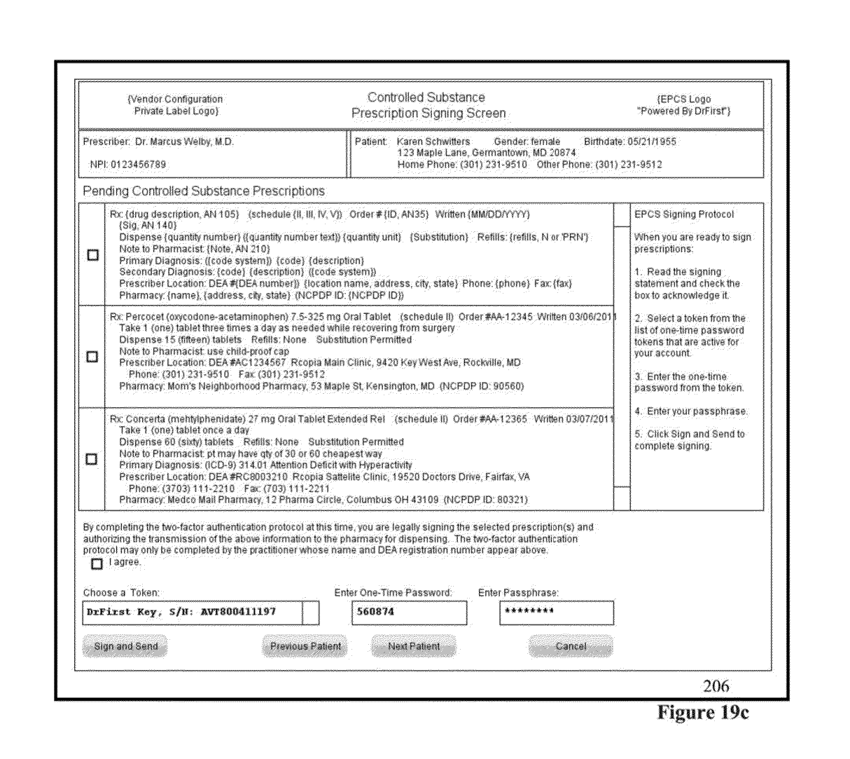

Turning now to FIGS. 11a-11e, one embodiment of processing an electronic prescription for a controlled substance is illustrated. The process begins when an authorized provider 201 generates a request for an electronic prescription of controlled substances using the HCP system 200. Referring to FIG. 11a, this request is then transmitted to and received by the EPCS module 600, completing step 1101. As noted above, the request is typically generated by the authorized provider 201 using the EP module 205, which resides on the HCP system 200. However, the invention is not so limited. In one alternate embodiment, the request can be generated within the EPCS module 600 itself. For example, an authorized provider 201 can log into the EPCS module 600 using a terminal 202 of the HCP system 200. This may be done via a web interface (web portal) or an application program user interface using a personal computer or mobile electronic device that is part of a HCP system 200. Depending on the embodiment, the provider 201 may choose a prescription for a controlled substance that they would like to generate and transmit electronically via the EPCS module 600 (as shown in FIG. 19a) before or after they access the EPCS module 600. Of course; the request for an electronic prescription of a controlled substance can be generated in a multitude of difference manners. Thus, the method described in FIG. 11a-11e begins when the EPCS module 600 receives at least one request for an electronic prescription for a controlled substance, regardless of how the request was generated and transmitted.

It should be noted that in the exemplified embodiment, the prescription for the controlled substance has been generated prior to the provider 201 accessing the EPCS module 600. Therefore, when the EPCS module 600 receives a request from an authorized provider 201 for an electronic prescription of a controlled substance, completing step 1101, the details of the electronic prescription itself [e.g., the patient name and information, at least one controlled substance, information relating to the at least one controlled substance (drug name, DEA schedule type, form, dosage, strength, quantity, refills, etc.), order number, date of the prescription, provider location, diagnosis, notes (instructions to patient and to pharmacy filling system) and desired pharmacy system 500 location] have been provided by the provider 201 and are contained within the electronic prescription request data. However, in alternate embodiments of the invention, the electronic prescription request that is received by the EPCS module 600 may contain none of the aforementioned information. In such instances, the EPCS module 600 would prompt the provider 201 to fill out the necessary information after receiving a request from a provider 201 for an electronic prescription of a controlled substance and validating the provider, thereby completing steps 1101 and 1102.

Further, in alternate embodiments, the EPCS module 600 may be initiated before the provider 201 has chosen a patient or a controlled substance. In such embodiments, the provider 201 first logs into the EPCS module 600 and requests an electronic prescription of a controlled substance prior to entering the specific information relating thereto. The request for the electronic prescription of a controlled substance in this embodiment can be received by the EPCS module 600 prior to, during, or after any related information is entered or submitted by the provider 201.

It should be noted that a controlled substance includes any schedule II, III, IV, V or VI substance as determined by the DEA. Thus, in certain embodiments, each electronic prescription request include data indentifying the representative Nation Drug Code Identification (NDC ID) and the schedule II, III, IV, V or VI drug status for the subject controlled substance. In the preferred embodiment, legend drugs (or non-controlled substances) should not be contemporaneously or integrally processed with controlled substances using the EPCS module 600. However, the invention is not so limited and in alternate embodiments, both controlled substances and legend drugs may be processed together using the EPCS module 600. Further, as government mandates regulating the electronic prescription of controlled substances are altered, the present invention may also be adapted accordingly.

Upon the EPCS module 600 receiving a request for an electronic prescription of a controlled substance, the EPCS module 600 first confirms that the provider 201 is an authorized provider, completing step 1102. In one embodiment, the EPCS module 600 also confirms that the HCP system 200 used by the provider 201 has also been authorized by the EPCS module 600. Thus, in such an embodiment, the EPCS module 600 validates that the provider 201 has been previously authenticated by the EPCS module 600 and that the provider 201 has been previously granted access to the EPCS module 600 by their HCP system 200. If the provider 201 has not been authenticated by the EPCS module 600 or has not been granted access to the EPCS module 600 by their HCP system 200, then the EPCS module 600 denies the request to electronically prescribe a controlled substance and displays an error message to the provider 201 in the display device 206 of the HCP system 200.

As discussed in more detail below, according to one embodiment of the present invention, the EPCS module 600 confirms that the request to electronically prescribe the subject control substance does not violate any federal or state rules and laws relating to: (1) the controlled substance generally; (2) electronically prescribing controlled substances; (3) the pharmacy system's ability to process an electronic prescription for a controlled substance; and (4) the provider's EPCS status (e.g., active or inactive). This is done through cross-referencing with appropriate databases that include the required information. Moreover, in accordance with one embodiment, the databases of the EPCS module 600 are automatically updated periodically (e.g., daily) with the current federal and state rules and laws as they relate to electronically prescribing controlled substances. As a result, the current federal and state rules and laws are stored in a database of the EP system 300, or other system, for cross-referencing by the EPCS module 600.

It should be noted that the EPCS module 600 may process multiple electronic prescription requests for controlled substances contemporaneously. In one such embodiment, the EPCS module 600 receives multiple electronic prescription requests for controlled substances at one time, which may relate to multiple patients. Thereafter, the provider 201 performs the signing process (described in more detail below) for each patient, but may prescribe more than one controlled substance prescription for each patient in one signing process. As also discussed in more detail below, the signing process is effectuated by the signing sub-module 603 of the EPCS module 600. Thereafter, the provider 201 performs the signing process for each subsequent patient until the signing process has been completed for each patient that is being electronically prescribed controlled substances. Also, in one embodiment, the EPCS module 600 may process multiple electronic prescription requests for controlled substances when not all of the prescription requests are issued from the same address and with the same provider DEA number.

in one embodiment, the electronic prescription request for a controlled substance will include a date on which it was created. The EPCS module 600 will analyze the date of creation to ensure that it is the current date. In one embodiment, the EPCS module 600 will only certify requests for electronic prescriptions whose date of creation matches the current date, not a past-date or a future effective date. Further, in another embodiment of the present invention, the EPCS module 600 will not process any electronic prescription requests for controlled substances if the controlled substance prescription has already been sent, printed or otherwise issued to the patient or pharmacy system 500. In such embodiments, the EPCS module 600 checks the audit database 305 to ensure that the request for the electronic prescription has not already been issued prior to certifying and transmitting the electronic prescription.

Referring back to FIG. 11a, the EPCS module 600 then performs a series of checks and confirmations to ensure that the prescription request meets required criteria. First, the EPCS module 600 transmits the prescription information relating to the controlled substance(s) and the requested pharmacy tilling sub-system 502 to the pharmacy system 500 for validation, completing step 1103. After the pharmacy system 500 receives the prescription information from the EPCS module 600, thereby completing step 1104, the pharmacy system 500 checks the controlled substance with a controlled substance database 505, thus completing step 1105. As noted above, the controlled substance database 505 has a list of all controlled substances, as opposed to legend drugs, which may be electronically prescribed by the pharmacy system 500. This may include information such as the NDC ID and schedule of the drug.

Therefore, the pharmacy system 500 determines whether the controlled substance is categorized as a controlled substance that can be electronically prescribed by the pharmacy system 500, completing step 1106. If the controlled substance listed on the prescription is not in the controlled substance database (e.g., the listed controlled substance is not actually a controlled substance or not authorized to be prescribed by the pharmacy system 500), then the pharmacy system generates an “Invalid” controlled substance response, thereby completing step 1107. Conversely, if the controlled substance listed on the prescription is in the controlled substance database, then the pharmacy system generates a “Valid” controlled substance response, thereby completing step 1108.

After a response is generated, the pharmacy system 500 checks the requested pharmacy filling sub-system 502 on the electronic prescription request with the pharmacy filling sub-system database 504, completing step 1109. This check is done to ensure that the pharmacy filling sub-system 502 listed on the prescription is capable of receiving not only electronic prescriptions, but also electronic prescriptions for controlled substances. Therefore, the pharmacy system 500 determines whether the requested pharmacy filling sub-system 502 is in the pharmacy filling sub-system database 504, completing step 1110. If the pharmacy filling sub-system 502 listed on the prescription is not in the pharmacy filling sub-system database 504, then the pharmacy system generates an “Invalid” pharmacy filling sub-system response, thereby completing step 1111. Conversely, if the pharmacy filling sub-system 502 listed on the prescription is in the pharmacy tilling sub-system database 504, then the pharmacy system generates a “Valid” pharmacy filling sub-system response, thereby completing step 1112. Thereafter, the pharmacy system 500 transmits both the controlled substance response and the pharmacy filling sub-system response to the EPCS module 600, completing step 1113.

The pharmacy system 500 also checks the provider's service level, which is stored in the provider database 503 to ensure that the provider 201 is authorized by the pharmacy system 500 to submit prescriptions for controlled substances electronically. In another embodiment of the present invention, the pharmacy system 500 will also confirm that the details of the electronic prescription are valid and do not exceed or conflict with any state laws relating to the electronic prescription of controlled substances using the controlled substance database 505. If the electronic prescription does exceed or conflict with state or federal government laws, then an error message is presented to the provider, as shown in the GUI of FIG. 19b. In other embodiments, these checks can be performed by the EPCS module 600.

The pharmacy system 500 may also check the prescription request against refill and duration rules, as regulated by the federal government or the state government. Finally, it should be noted that alternate embodiments any number of the above mentioned checks and confirmations performed by the pharmacy system 500 may be combined or omitted, or performed by the EPCS module 600 using the appropriate databases.

Next, the EPCS module 600 receives the controlled substance response and the pharmacy tilling sub-system response from the pharmacy system 500, completing step 1114. The EPCS module 600 determines whether the controlled substance response is “Valid,” completing step 1115. If the response is “Invalid,” then the process is ended and an error message is displayed to the provider 201, completing step 1116. However, if the response is “Valid,” then the process continues and the EPCS module 600 determines whether the pharmacy filling sub-system response is “Valid,” completing step 1117. Similarly, if the response is “Invalid,” then the process is ended and an error message is displayed to the provider 201, completing step 1118. But if the response is “Valid,” then the process continues and prescription is displayed to the provider 201 via the HCP system 200 for their review, completing step 1119.

Referring to FIG. 11c, after the EPCS module 600 receives confirmation from the pharmacy system 500 that the prescription is valid, the EPCS module 600 displays the details of all of the requests for an electronic prescription of a controlled substance to the provider 201 for review in a GUI generated by the EPCS module 600 and displayed in the display device 206 of the HCP system 200, completing step 1119. As noted above, if more than one prescription is being filled simultaneously, all of the prescriptions may be displayed to the provider 201 contemporaneously. In the exemplified embodiment, the EPCS module 600 requests that the provider 201 review the provider's information (e.g., provider's name, address and DEA number), the date of the request for an electronic prescription of a controlled substance, the full name of the patient, patient information (e.g., patient address, birth date and gender if available), the controlled substance information (e.g., name, dosage, strength, form and DEA schedule), instructions to the patient and pharmacy tilling sub-system 502, the quantity of the controlled substance prescribed, the refills authorized by the provider 201, and the National Council for Prescription Drug Programs (NCPDP) number of the pharmacy filling system. After the provider 201 reviews the above noted details, the provider 201 confirms the accuracy of the request for an electronic prescription of a controlled substance with the EPCS module 600 through interaction with the GUI using the input device 207 of the HCP system 200, thereby completing step 1120. After confirmation is received by the EPCS module 600, the signing process of the electronic prescription is initiated at step 1121.

In accordance with one embodiment of the present invention, if any of the requests for an electronic prescription of a controlled substance fail any of the required criteria listed above, then the EPCS module 600 generates an error message that is displayed to the provider on the display device 206 along with the information relating to that specific request for an electronic prescription of a controlled substance. As a result, the provider 201 may see exactly why a specific request for an electronic prescription of a controlled substance cannot be processed by the EPCS module 600. If desired, the provider 201 may then choose to edit any requests for an electronic prescription of a controlled substance and alter any data of the request for an electronic prescription of a controlled substance, regardless of whether it comprises an error message. Further, the provider 201 may also choose to remove any requests for an electronic prescription of a controlled substance prior to beginning the signing process. Nonetheless, according to one embodiment of the present invention, the provider 201 will not edit the requests for an electronic prescription of a controlled substance in the EPCS module 600, but rather will be redirected back to the EP module 205 to edit the request for an electronic prescription of a controlled substance. In such embodiments, after the provider 201 has made the appropriate edits to their requests for an electronic prescription of a controlled substance, the process returns to step 1101 and the provider 201 resubmits their requests for an electronic prescription of a controlled substance.

Moreover, according to one embodiment of the present invention, the provider 201 can also be provided with a means to select only a portion of request for an electronic prescription of a controlled substance for which the signing process is to be performed. The EPCS module 600, via the signing sub-module 603, will only transmit those portions of the request for an electronic prescription of a controlled substance to the pharmacy system 500 at that specific time. Therefore, although the provider 201 may have entered more than one request for an electronic prescription of a controlled substance into the EPCS module 600, the provider 201 may choose to sign and certify only a select few using the signing process of the EPCS module 600 described below.

Similar to the provider 201 authorization process described above, the signing process comprises the multi-factor authentication process. As noted above, the exemplified embodiment of the multi-factor authentication process comprises two factors, the first identification factor (e.g., a passphrase) and the second identification factor (e.g., a one-time password). However, as previously noted, the invention is not so limited and in alternate embodiments the multi-factor authentication process may comprise more and/or different identification factors than are explicitly described herein.

In the exemplified embodiment, the provider 201 completes the multi-factor authentication process while the details of the request for an electronic prescription of a controlled substance and a signing statement are displayed. The signing statement is a statement attested to by the provider 201 that they understand that the signing process will electronically sign and send the requests for an electronic prescription of a controlled substance.

In the exemplified embodiment, the multi-factor authentication process is a two factor authentication process that comprises the provider 201 inputting their first identification factor (e.g., a passphrase), selecting their second identifier (which may be done by selecting a previously named second identifier or by entering the unique marker of a second identifier) and inputting a second identification factor (e.g., a one-time password that is generated by the second identifier) into a GUI generated by the EPCS module 600 and displayed on the display device 206 of the HCP system 200. As noted above, the first identification factor was previously created by the provider 201 during the authentication process and stored in the first identification factor database 304 of the EP system 300 by the EPCS module 600.

According to the exemplified embodiment, the second identifier is a token (hard or soft) that has previously been bound to the provider 201 using the authentication process described above. A particular provider 201 may be bound to multiple second identifiers and may create a name for each of their second identifiers (even if they only have one). Each of these names is stored in at least the first identification factor database 304 of the EP system 300 by the EPCS module 600. For instance, if the provider 201 is associated with more than one HCP system 200, then the provider 201 may have a different second identifier associated with each HCP system 200. Therefore, in step 1122, the provider 201 is required to choose a second identifier from a list that is generated by the EPCS module 600 and displayed to the provider 201 via the display device 207 (wherein each second identifier has been previously bound to the provider 201).

In the exemplified embodiment, the second identification factor is a one-time password that is generated by the chosen second identifier and is known only to the third party IDV system 400. According to one embodiment, the provider 201 activates their second identifier (e.g., by pressing a button or scanning a particular biometric of the provider) to receive the second identification factor. However, as discussed above, the invention is not so limited and in alternate embodiments the second identification factor may be any other means (e.g., a biometric) used by the third party IDV system 400 to validate the identity of the provider 201.

The EPCS module 600 receives the first identification factor from the HCP system 200 after the provider 201 has inputted the first identification factor into the appropriate GUI that is generated by the EPCS module 600, thereby completing step 1121. Next, the EPCS module 600 receives a selection of a previously bound second identifiers from the HCP system 200 after the provider 201 has inputted the previously bound second identifier into the appropriate GUI that is generated by the EPCS module 600, thereby completing step 1122. Then, the EPCS module 600 receives a second identification factor from the HCP system 200 after the provider 201 has inputted the second identification factor into the appropriate GUI that is generated by the EPCS module 600, thereby completing step 1123. In the exemplified embodiment, the provider 201 enters all of this information into a single GUI and transmits all this information contemporaneously to the EPCS module 600, as shown in the GUI of FIG. 19c. However, the invention is not so limited, and in other embodiments, the HCP system 200 transmits each of the three pieces of information (first identification factor, second identifier and second identification factor) separately to EPCS module 600.

After the first and second identification factors are received by EPCS module 600, the EPCS module 600 time stamps the second identification factor so it can be later validated by the third party IDV system 400 (as discussed above). Next, the EPCS module 600, confirms the validity of the first identification factor with the provider's information through appropriate cross-referencing using the data stored in the first identification factor database 304, thereby completing step 1124. Through this cross-referencing, the EPCS module 600 determines whether the received first identification factor correlates with the first identification factor of the provider 201 that is stored in the first identification factor database 304 of the EP system 300, completing step 1125. It should be noted that in alternate embodiments, the first identification factor database 304 may reside on another system or module other than the EP system 300.

If the received first identification factor is determined by the EPCS module 600 to not match the first identification factor stored in the first identification factor database 304, then the EPCS module 600 generates an error message and the process ends at step 1126. However, if the received first identification factor is determined by the EPCS module 600 to match the first identification factor stored in the first identification factor database 304, then the process advances to step 1127. At step 1127, the EPCS module 600 transmits the unique marker of the second identifier, the time stamp, and the second identification factor to the third party IDV system 400 for evaluation.

According to one embodiment, prior to transmitting the unique marker, the time stamp, and the second identification factor to the third party IDV system 400, the EPCS module 600 confirms that the unique marker entered by the provider 201 matches with a unique marker stored in associated with the provider 201 in the unique marker database 206 of the HCP system 200. This is accomplished via cross-reference and comparison techniques as known in the art.

Referring to FIG. 11d, the third party IDV system 400 receives the unique marker of the second identifier, the time stamp, and the second identification factor from the EPCS module 600, completing step 1128. Thereafter, the third party IDV system 400 confirms the validity of the second identification factor using the time stamp, the received second identification factor, the unique marker, and the algorithm stored in the second identification factor database 405 of the third party IDV system 400, as discussed above in detail, thereby completing step 1129. The third party IDV system 400 confirms that the second identification factor provided is valid in accordance with its algorithm, completing step 1130. Since the EPCS module 600 does not know the validity of the second identification factor, the third party IDV system 400 performs the validation. If the second identification factor is determined by the third party IDV system 400 to be invalid, then the third party IDV system 400 generates an “Invalid” second identification factor response, completing step 1131. However, if the second identification factor is determined by the third party IDV system 400 to be valid, then the third party IDV system 400 generates a “Valid” second identification factor response, completing step 1132. Thereafter, the third party IDV system 400 transmits the second identification factor response to the EPCS module 600, completing step 1133.

Referring to FIG. 11e, the EPCS module 600 receives the response from the third party IDV system 400, completing step 1134. After the response is received, the EPCS module 600 determines whether the second identification factor response is “Valid,” completing step 1135. If the second identification factor response is “Invalid,” then the EPCS module 600 generates an error message, which is displayed to the provider via the display device 206, and the process is ended at step 1136. However, if the second identification factor response is “Valid,” then the process continues. Further, if the response is “Valid,” then the first and second identification factors provided by the provider 201 are valid and the multi-factor authentication process is complete.

Next, the EPCS module 600 generates a digital signature of the provider 201 at step 1137. In the exemplified embodiment, after creating the digital signature, the EPCS module 600 associates the digital signature to the electronic prescription of the controlled substance, thereby completing step 1138. In the exemplified embodiment, the digital signature is a series of numbers and/or letters that correlate the provider 201 with the specific electronic controlled substance prescription. The data included in the digital signature is the provider's information (e.g., provider's name, address and DEA number), the date of the request for an electronic prescription of a controlled substance, the full name of the patient, patient information (e.g., patient address, birth date and gender if available), the controlled substance information (e.g., name, dosage, strength, form and DEA schedule), instructions to the patient and pharmacy filling system, the quantity of the controlled substance prescribed and the refills authorized by the provider 201. However, the invention is not so limited and in alternate embodiments the digital signature may include additional information or only a portion of the information listed above.

According to one embodiment of the present invention, before the digital signature is generated by the EPCS module 600, the status of the provider's signature certificate is checked with a certificate authority's revocation list (CRL). The digital signature is generated by the EPCS module 600 from a system certificate, which in turn is chained to a third-party certificate authority that is cross-certified with the Federal Bridge.

After the digital signature is created by the EPCS module 600, the electronic prescription of the controlled substance along with the associated digital signature is saved in the audit database 305 of the EP system 300. In the exemplified embodiment, the audit database 305 is a database that stores, among other things, all of the information relating to each electronic prescription for controlled substances processed by the EPCS module 600. In one embodiment, the audit database 305 is sorted by provider 201 and HCP system 200. The associated digital signatures are important for record keeping and auditing purposes.

After the EPCS module 600 associates the digital signature with the electronic prescription for the controlled substance and saves the digital signature and associated electronic prescription in the audit database 305 of the EP system 300, the EPCS module 600 creates a payload. The payload is an electronic document that includes a portion or all of the information relating to each the electronic prescription processed by the EPCS module 600 that is to be transmitted and filled by the pharmacy system 500. Prior to transmitting the payload to the pharmacy system 500 (which may done by either the HCP system 200, the EPCS module 600, the EP system 300 or other system or module of the system 100), the EPCS module 600 attaches a certification indicator to each electronic prescription, as described in more detail below. Therefore, according to one embodiment, the payload comprises multiple electronic prescriptions and their associated certification indicators. As noted above, after the payload is created, the EPCS module 600 (or other system/module of the system 100) transmits the payload to the pharmacy system 500 for further processing (e.g., filling the prescription for patient pick-up).

Referring back to FIG. 11e, after the electronic prescription and associated digital signature is stored in the audit database 305, the EPCS module 600 attaches a certification indicator to create a certified electronic prescription, completing step 1140. According to one embodiment of the present invention, the EPCS module 600 does not attach the digital signature to the electronic prescription, but rather attaches a certification indicator. This is because, in the exemplified embodiment, the pharmacy system 500 that will ultimately be receiving and routing the electronic prescription cannot read the digital signature. Rather, the pharmacy system 500 can process the certification indicator by reading an indicator field of the electronic prescription to confirm that the electronic prescription has been certified by the EPCS module 600. Therefore, to ease the processing of the electronic prescription by the pharmacy system 500, the EPCS module 600 does not attach the digital signature, but rather attaches the certification indicator to the electronic prescription.

However, the invention is not so limited and in other embodiments, the EPCS module 600 attaches the digital signature to the electronic prescription, and then transmits the electronic prescription with attached digital signature (and not certification indicator) to the pharmacy system 500. In such embodiments, the EPCS module 600 stores the electronic prescription and attached digital signature in the audit database 305.

Referring back to FIG. 11e, after the EPCS module 600 attaches the certification indicator to the electronic prescription (to create a certified electronic prescription), the EPCS module 600 transmits the certified electronic prescription to the prescription routing sub-system 501 of the pharmacy system 500 for processing, completing step 1141. Thereafter, the prescription routing sub-system 501 receives the certified electronic prescription at step 1142, and transmits (or routes) the certified electronic prescription to the appropriate pharmacy filling sub-system 502 where the prescription for the controlled substance may be filled and dispersed to the patient, completing step 1143. As noted above, the prescription filling sub-system 502 is preferably the chosen pharmacy of the patient. It should be noted that, in one embodiment of the present invention, prior to the prescription routing sub-system 501 transmitting the certified electronic prescription to the pharmacy tilling sub-system 502, the prescription routing sub-system 501 confirms that the electronic prescription has been certified by the EPCS module 600. Further, in an alternate embodiment, the prescription routing sub-system 501 may further confirm that the provider 201 is authenticated in their provider database 503 prior to transmitting the certified electronic prescription to the appropriate prescription tilling sub-system 502.

In another alternate embodiment of the present invention, after the EPCS module 600 attaches the certification indicator to the electronic prescription, the EPCS module 600 transmits the certified electronic prescription to the HCP system 200. In such embodiments, the EPCS module 600 may transmit the certified electronic prescription to the client portion 601 of the EPCS module 600 that resides on the HCP system 200. Thereafter, the client portion 601 of the EPCS module 600 transmits the certified electronic prescription to the pharmacy system 500 for processing. In such an embodiment, the client portion 601 of the EPCS module 600 acts as a routing system for the EPCS module 600 so that the certified electronic prescriptions are received by the pharmacy system 500 via the HCP system 200.

After the provider 201 has successfully completed the above described process for processing an electronic prescription for one patient, the provider 201 may then review and send prescriptions for another patient using the above mentioned processes. According to one embodiment, the provider 201 reviews the requests for an electronic prescription of a controlled substance generated by the EPCS module 600 via the display device 206 and the above described process (steps 1101-1143) are performed by the respective systems/modules for each subsequent patient. However, in an alternate embodiment, the provider 201 may select prescriptions for multiple patients prior step 1101. In such embodiments, the EPCS module 600 authenticates the requests for electronic prescriptions of controlled substances for each patient using the two-factor authentication process described above to generate certified electronic prescriptions for each patient, followed by the EPCS module 600 transmitting all of the certified electronic prescriptions at one time to the pharmacy system 500 for processing.

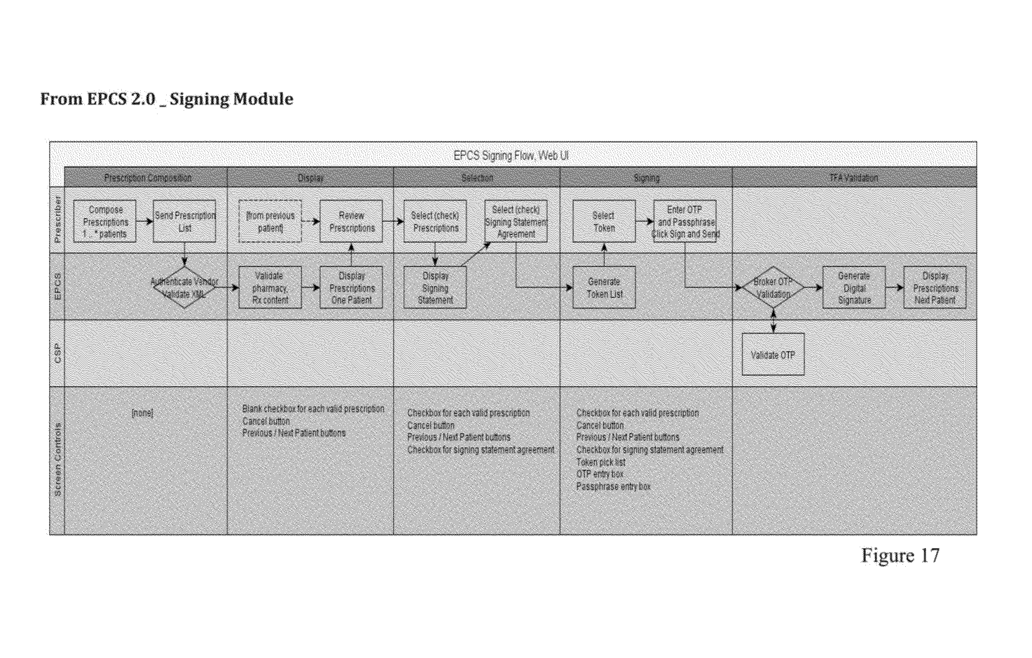

Referring to FIG. 17, an alternate embodiment of electronically prescribing a controlled substance using the EPCS module 600 is illustrated. As exemplified in FIG. 17, it should be noted that “Prescriber” stands for the provider 201 and “CSP” stands for the third party IDV system 400 of the present invention.

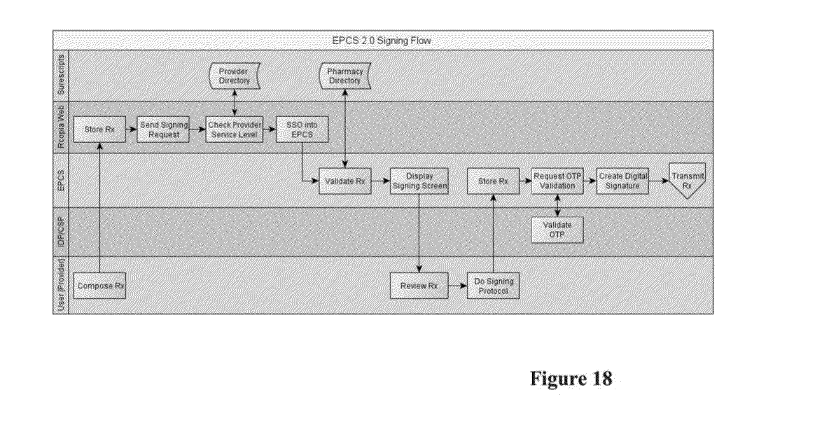

Further, referring to FIG. 18, another alternate embodiment of electronically prescribing a controlled substance using the EPCS module 600 is illustrated. As exemplified in FIG. 18, it should be noted that “EPCS” stands for the EPCS module 600, “Rcopia Web®” stands for the EP module 205, “Surescripts®” stands for the pharmacy system 500 and “IDP/CSP” stands for the third party IDV system 400 of the present invention.

While the embodiment of the present invention has been described with reference to the accompanying drawings, it can be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1-108. (canceled)

109. A method for electronically prescribing a controlled substance on a wide area network, the wide area network comprising, in operable electronic communication, a health care provider system (HCP system), an electronic prescription system (EP system), a third party identification validation system (third party IDV system), and a pharmacy system, the method comprising:
a) the EP system receiving from the HCP system an electronic prescription entered by a provider for a controlled substance, a first identification factor, and a second identification factor;
b) the EP system authenticating the first identification factor and transmitting the second identification factor to the third party IDV system for authentication; and
c) upon the first identification factor being approved by the EP system and the EP system receiving approval of the second identification factor from the third party IDV system, the electronic prescription being certified for transmission to the pharmacy system as a certified electronic prescription for the controlled substance.

110. The method of claim 109 wherein the certification of the electronic prescription comprises adding a certification indicator to the electronic prescription to create the certified electronic prescription.

111. The method of claim 110 wherein the certification indicator is added by an electronic prescription of controlled substances (EPCS) module.

112. The method of claim 111 wherein a client portion of the EPCS module resides on the HCP system and a centralized portion of the ECPS module resides on the EP system, the client portion of the ECPS module adding the certification indicator to the electronic prescription to create the certified electronic prescription, the HCP system transmitting the certified electronic prescription to the pharmacy system.

113. The method of claim 109 wherein the certification of the electronic prescription comprises:
c-1) associating a digital signature to the electronic prescription; and
c-2) storing the electronic prescription with the associated digital signature in an audit database.

114. The method of claim 109 wherein step a) comprises the provider inputting the first identification factor and the second identification factor using the HCP system in response to a multi-factor identification authentication request issued by an electronic prescription of controlled substances (EPCS) module.

115. The method of claim 109 wherein the authenticating of the first identification factor by the EP system comprises the EP system cross-referencing the first identification factor with a previously established first identification factor stored in a first identification factor database of the EP system.

116. The method of claim 115 wherein establishment of the previously established first identification factor comprises: validating the provider's identity using an application program interface (API) of the third party IDV system that is integrated into an authentication interface of an electronic prescription of controlled substances (EPCS) module that is displayed on the HCP system.

117. The method of claim 116 wherein the step of validating the provider's identity comprises:
the third party IDV system generating questions specific to the provider and displaying the questions on the HCP system via the API;
the third party IDV system receiving answers to the questions from the provider; and
upon the answers to the questions meeting a required threshold of accuracy, transmitting an identity authentication signal to the EP system.

118. The method of claim 109 wherein the second identification factor is one of a one-time password generated by a token or a biometric of the provider; and wherein the first identification factor is a password created by the provider.

119. The method of claim 109 wherein the second identification factor is unknown to the EP system.

120. The method of claim 109 further comprising, prior to step a), the third party IDV system delivering a second identifier that generates the second identification to the provider as a result of the EP system receiving a request that the provider be authenticated for electronic prescription of controlled substances.

121. The method of claim 120 further comprising, prior to step a), the EP system receiving the request that the provider be authorized for electronic prescription of controlled substances from the HCP system; and transmitting to the third party IDV system at least a portion of the provider's information and a request to deliver the second identifier to the provider.

122. The method of claim 109 wherein the pharmacy system comprises a prescription routing sub-system and at least one prescription filling sub-system, the method further comprising:
d) the HCP system transmitting the certified electronic prescription to the prescription routing sub-system;
e) the prescription routing sub-system transmitting the certified electronic prescription to the at least one prescription filling sub-system; and
f) the at least one prescription filling sub-system filling the certified electronic prescription.

123. The method of claim 109 further comprising the EP system time stamping the second identification factor prior to transmitting the second identification factor to the third party IDV system, the transmitted second identification factor comprising the time stamp.

124. A method for electronically prescribing a controlled substance on a wide area network, the wide area network comprising, in operable electronic communication, a health care provider system (HCP system), an electronic prescription system (EP system), an electronic prescription of controlled substances (EPCS) module, a third party identification validation system (third party IDV system), and a pharmacy system, the method comprising:
a) the EPCS module receiving from the HCP system an electronic prescription entered by a provider for a controlled substance, a first identification factor, and a second identification factor;
b) the EPCS module authenticating the first identification factor using a first identification factor database residing on the EP system and transmitting the second identification factor to the third party IDV system for authentication; and
c) upon the first identification factor being approved by the EPCS module and the EPCS module receiving approval of the second identification factor from the third party IDV system, the EPCS module certifying the electronic prescription for transmission to the pharmacy system as a certified electronic prescription for the controlled substance

125. The method of claim 124 wherein a client portion of the EPCS module resides on the HCP system and a centralized portion of the ECPS module resides on the EP system, the client portion of the ECPS module adding the certification indicator to the electronic prescription to create the certified electronic prescription, the HCP system transmitting the certified electronic prescription to the pharmacy system.

126. The method of claim 125 wherein step c) further comprises:
c-1) associating a digital signature to the electronic prescription;
c-2) storing the electronic prescription with the associated digital signature in an audit database residing on the EP system;
c-3) adding a certification indicator to the electronic prescription to create the certified electronic prescription; and
wherein the centralized portion of the EPCS module performs steps c-1) and c-2), and the client portion of the ECPS module performs step c-3).

127. The method of claim 124 further comprising:
the EPS module authenticating the first identification factor by cross-referencing the first identification factor with a previously established first identification factor that is stored in the first identification factor database of the EP system; and
wherein the previously established first identification factor is established by validating the provider's identity using an application program interface (API) of the third party IDV system that is integrated into an authentication interface of the EPCS module that is displayed on the HCP system.

128. The method of claim 124 wherein the second identification factor is a one-time password generated by a second identifier and the EP system comprises a database storing a unique marker of the second identifier; and wherein step b) further comprises the EPCS module generating a time stamp upon receiving the second identification factor from the HCP system, the EPCS module retrieving the unique marker from the database of the EP system, and EPCS module transmitting the unique marker, the time stamp and the second identification factor to the third party IDV system for authentication.

129. A method for a provider to electronically prescribe controlled substances comprising:
an electronic prescription for controlled substance (EPCS) module validating identity of the provider and binding a second identifier to the provider using a third party identification vendor (IDV) system;
the EPCS module receiving a controlled substance prescription from the provider;
the EPCS module authorizing the provider using the third party IDV system;
the EPCS module certifying the controlled substance prescription; and
the EPCS module electronically transmitting the certified controlled substance prescription to a health care provider (HCP) system.

130. A method for a provider to electronically prescribe controlled substances comprising:
an electronic prescription (EP) system validating identity of the provider and binding a second identifier to the provider using a third party identification vendor (IDV) system;
the EP system receiving a controlled substance prescription from the provider;
the EP system authorizing the provider using the third party IDV system;
the EP system certifying the controlled substance prescription;
the EP system electronically transmitting the certified controlled substance prescription to a pharmacy system; and
the pharmacy system receiving the certified controlled substance prescription.
